(19) United States
(12) Patent Application Publication
(10) Pub. No.: US 2006/0075503 A1
(43) Pub. Date: Apr. 6, 2006

(54) Method and system for applying security vulnerability management process to an organization

(75) Inventors: Nelson Waldo Bunker V, Allen, TX (US); Eva Elizabeth Bunker, Dallas, TX (US); Kevin Michael Mitchell, Dallas, TX (US)

Correspondence Address: HOWISON & ARNOTT, L.L.P, P.O. BOX 741715, DALLAS, TX, 75374-1715, US

(73) Assignee: Achilles Guard, Inc. dba Critical Watch

(21) Appl. No.: 11/225,411

(22) Filed: Sep. 13, 2005

Related U.S. Application Data
(60) Provisional application No. 60/609,267, filed on Sep. 13, 2004.

(51) Int. Cl. G06F 11/30

(52) U.S. Cl. 726/25; 726/1

(57) ABSTRACT

The present invention comprises a graphical user interface for managing vulnerability life cycle of a computer network of an organizational entity. The graphical user interface includes a multilevel tree structure including a plurality of nodes. Each node of the plurality of nodes is uniquely associated with a designated unit within the organizational entity. The graphical user interface further includes at least one user icon connected to at least one of the nodes wherein the at least one user icon is associated with a particular individual. At least one group icon is connected to at least one of the nodes wherein the group icon is associated with a plurality of individuals. Each of the plurality of nodes, the at least one user icon and the at least one group icon are dynamically modifiable according to a structure of the organizational entity.

### CROSS-REFERENCE TO RELATED APPLICATIONS

This application claims priority from U.S. Provisional Application Ser. No. 60/609,267 entitled “METHOD AND SYSTEM FOR APPLYING TECHNICAL VULNERABILITY MANAGEMENT PROCESSES TO AN ORGANIZATION,” FILED Sep. 13, 2004 and is incorporated herein by reference.

### TECHNICAL FIELD OF THE INVENTION

This invention is related to security vulnerability management processes, and more particularly, to a system and method for applying vulnerability management processes to a particular organization.

### BACKGROUND OF THE INVENTION

Known security vulnerabilities present the greatest electronic security risks now confronting network organizations. Such vulnerabilities must be guarded against in order for enterprises to secure their networks to meet their regulatory and business requirements.

Network vulnerabilities, as well as the frequency and sophistication of network attacks, are substantial and growing. Piecemeal and inefficient processes such as random audits, scanners, and consulting engagements have been utilized, but such processes leave an organization exposed to a high level of risk and typically fail to demonstrate a high level of business and regulatory compliance. These methods sometimes fail because they don't allow security to be embedded as an ongoing operational process, they do not scale especially against the backdrop of a very complex and dynamic organization. Many of today's organizations are computing “ecosystems” created to serve multiple entities that are operationally independent or semi-independent while being interconnected from a computing network perspective. Even though these entities are managed autonomously, their networks must be collectively secured in a coherent process covering the entire computing ecosystem. In addition to this, organizations now rely upon information and communication technologies to such an extent that a serious breach of security could likely have serious adverse business consequences, such as loss of important data or, more likely, theft or publication of confidential information. The legal consequences of network vulnerabilities are also increasing dramatically. Sarbanes Oxley, Graham Leach Bliley, HIPAA, and Homeland Security have all dramatically increased the level of security that organizations are required by law to maintain.

One approach to the problem of network security has been to apply these conventional tools, tools which are not designed for true enterprise scalability or operational management, with greater frequency. However, this approach requires a significant increase in personnel. In addition, without an unrealistically large increase in personnel, such tools cannot be applied on a continuous basis. The result has been incomplete, periodic, and ad hoc assessment attempts. The problem with this approach is that with daily new vulnerability emerging, as well as network changes, security vulnerabilities can exist between assessments or outside consultant's engagements, which keep the security risk high in spite of the amount of money spent on the problem.

Another approach to the increasing problems plaguing network vulnerability management has included automation of technical tasks which were previously manually intensive; for example, asset labeling and management. However, these approaches have typically failed to dictate assessment jobs, define a reporting structure, and assign personnel roles and responsibilities. These approaches fail to automate the entire vulnerability management life cycle from finding the computers and network assets to testing them, prioritizing the risk, providing remediation steps, assigning the tasks to asset owners, reporting and measuring the results or alerting on new vulnerabilities affecting the assets.

One reason that such approaches have not proven sufficient for today's computing ecosystem enterprises is due to their having insufficient flexibility and sophistication to embed all aspects of a vulnerability management life cycle process based on a unique organizational or business taxonomy in a multi-constituent (asset owner) environment. Organizations today are complex and distributed with unique business risk priorities that vary even within internal groups.

What is clearly needed is a consistent preventative vulnerability management process that can be systematically applied, maintained and measured across large scale distributed ecosystem environments.

### SUMMARY OF THE INVENTION

The present invention disclosed and described herein, in one aspect thereof, comprises a graphical user interface for managing the life cycle of security vulnerability management of a computer network of an organizational entity. The graphical user interface includes a multilevel tree structure to n layers including a plurality of nodes. Each node of the plurality of nodes is uniquely associated with a designated unit within the organizational entity. The graphical user interface includes at least one user icon connected to at least one of the nodes. The user icon being associated with a particular individual. The graphical user interface further includes at least one group icon connected to at least one of the nodes. The group icon being associated with a plurality of individuals. Each of the plurality of nodes, the at least one user icon and the at least one group icon are dynamically modifiable according to a structure of the organizational entity.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an organizational entity to which the present invention may be applied;

FIG. 2 illustrates the manner in which the present invention may provide a cohesive approach to a disparate group of technical functions;

FIG. 3 is a functional block diagram of a system for vulnerability assessment;

FIG. 4 is an illustration of the risk level of a network over time using the present invention;

FIG. 5 is an illustration of a distributed infrastructure for carrying out a technical vulnerability management process;

FIG. 6 illustrates the process by which the present invention may be used to manage the network vulnerabilities for an organizational entity;

FIG. 7 is a functional block diagram of a system for managing network vulnerabilities;

FIG. 8 is a flow diagram illustrating the manner in which a vulnerability assessment system may be used to manage the vulnerabilities of a particular organizational entity;

FIG. 9 illustrates a graphical user interface provided by a collaborative execution map module;

FIG. 10 illustrates a graphical user interface for editing node information and providing permissions to groups and users;

FIG. 11 illustrates a graphical user interface for editing user information, permissions for objects and tabs;

FIG. 12 illustrates a graphical user interface for editing group information, permissions for objects and tabs;

FIGS. 13a and 13b are examples of tree structures that may be associated with a particular organizational entity;

FIG. 14 is a flow diagram illustrating the process for adding a node to the tree structure of the CEM module;

FIG. 15 is a flow diagram illustrating the process for editing a node within the tree structure of the CEM module;

FIG. 16 is a flow diagram illustrating the process for deleting a node from the tree structure of the CEM module;

FIG. 17 is a flow diagram illustrating the process for adding a group to the tree structure of the CEM module;

FIG. 18 is a flow diagram illustrating the process for modifying a group of the tree structure of the CEM module;

FIG. 19 is a flow diagram illustrating the process for deleting a group from the tree structure of the CEM module;

FIG. 20 is a flow diagram illustrating the process for adding a user to a group or node of the tree structure of the CEM module;

FIG. 21 is a flow diagram illustrating the process for editing a user's settings;

FIG. 22 is a flow diagram illustrating the process of deleting a user from a particular group or node within the tree structure of the CEM module;

FIG. 23 illustrates a graphical user interface associated with the jobs manager module;

FIGS. 24a-c illustrate a graphical user interface of the jobs details and permission page;

FIG. 25 is a flow diagram illustrating the process for adding a job within the jobs manager module;

FIG. 26 is a flow diagram illustrating the process for editing a job within the jobs manager module;

FIG. 27 is a flow diagram illustrating the process for deleting a job from the jobs manager module;

FIG. 28 illustrates the schedule manager page within the jobs manager module;

FIG. 29a illustrates the operational windows listing within the jobs manager module;

FIG. 29b illustrates the calendar window;

FIG. 30 illustrates the schedule details and permissions page within the jobs manager module;

FIG. 31 illustrates the operational window details and permission page within the jobs manager module;

FIG. 32 is a flow diagram illustrating the process for creating a schedule within the jobs manager module;

FIG. 33 is a flow diagram illustrating the process for modifying a schedule within the jobs manager module;

FIG. 34 is a flow diagram illustrating the process for deleting a schedule from the jobs manager module;

FIG. 35 is a flow diagram illustrating the process for creating an operational window within the jobs manager module;

FIG. 36 is a flow diagram illustrating the process for editing an operational window within the jobs manager module;

FIG. 37 is a flow diagram illustrating the process for deleting an operational window from the jobs manager module;

FIG. 38 is a flow diagram illustrating the process for accessing reports within the reports module;

FIG. 39a-c illustrates a report displayed under the charts tab;

FIG. 40 illustrates a report provided under the screen display of the charts tab and the trend tab of the charts tab;

FIG. 41 illustrates a report displayed responsive to selection of a report by risk;

FIG. 42 illustrates a report provided responsive to selection of a report by host;

FIG. 43 illustrates a report provided responsive to selection of the profiles tab;

FIG. 44 illustrates a report provided responsive to selection of the early warning alerts tab;

FIG. 45 illustrates a report provided responsive to selection of the open services tab;

FIG. 46 illustrates a variance report; and

FIG. 47 illustrates the use of color coding for scoring the security levels within the tree structure.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

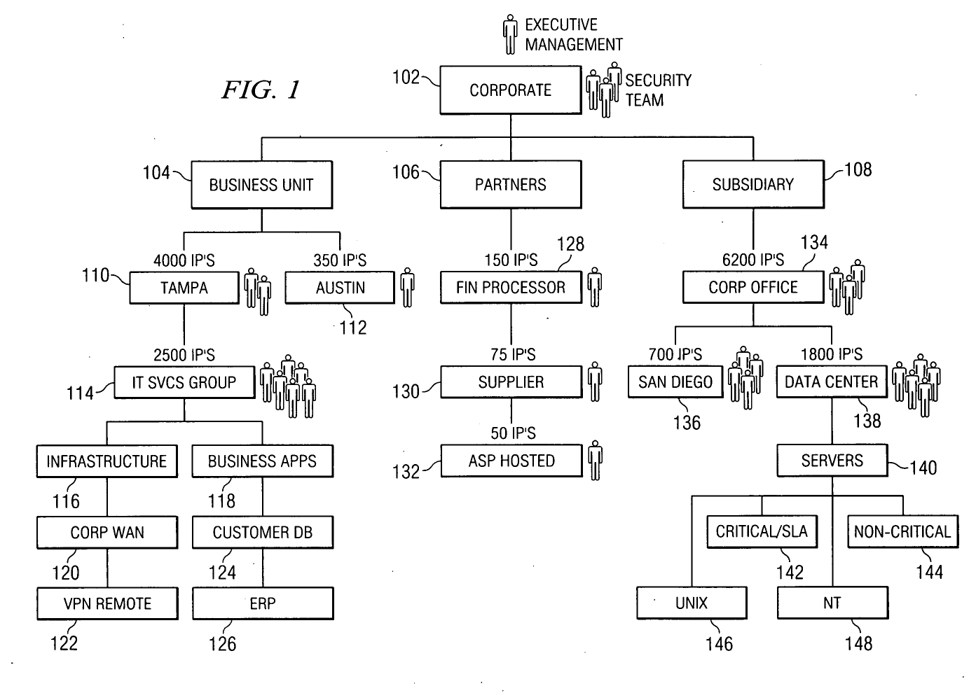

Referring now to the drawings, and more particularly to FIG. 1, there is provided an illustration of the classic problem within a particular organizational entity for them to organize, assess and report on the various vulnerabilities existing within their organization. The overall organizational entity 102 includes a business unit grouping 104, partners 106 and various subsidiaries 108. Each of these organizational groupings has various IP addresses associated therewith, which must be inventoried, managed and protected by the corporation. The business units groups 104 consist of a Tampa division 110 and an Austin division 112. The Tampa division has a total of 4,000 IP addresses associated therewith while the Austin division has 350 IP addresses associated therewith. Broken down into further sub-groups, the Tampa division 110 includes the IT services group 114 that has 2,500 of the 4,000 IP addresses associated therewith. The IT services group can further be broken down into the infrastructure group 116 and the business applications group 118. The infrastructure group further includes the corporate-wide area network 120 and the remote virtual private network 122. The business applications group 118 includes the customer database 124 and the ERP 126. This methodology can continue to represent an organization entity structure to its n layers.

The partners 106 may further be broken down into the financial processor 128 including 150 IP addresses, the supplier 130 including 75 IP addresses and the ASP host 132 including 50 IP addresses. The subsidiaries 108 include the corporate offices 134 having a total of 6,200 IP addresses with the San Diego office including 700 IP addresses and the data center including 1,800 IP addresses. The data center 138 may further be broken down into servers 140, critical/SLA 142, non-critical devices 144, unix devices 146 and MP devices 148.

For a security team managing this corporate network infrastructure, they must juggle tasks in organizing thousands of different IP addresses. In many cases, individuals will have no span of control (administrative authority) over particular assets. They are required to manually filter false positives and e-mail important issues after a review has been completed. Scanner tools may scan the network on an ad hoc basis every few months. The scanning may cause the generation of periodic risk assessment reports requiring months of follow-up and meetings. In many cases, the reports must be manually created for management. This particular implementation would only be beneficial to this business structure. A corporate entity may many times reorganize its business structure thus requiring a reorganization of the vulnerability assessment systems or systems for vulnerability management which may be configured to work with a particular type of corporate setup but not with a different setup having differing priorities and goals than the corporate setup for which the system was originally designed. The question is how a distributed enterprise with multiple divisions manages their distributed networks and systems and has visibility, measurability and control over their enterprise infrastructure to be compliance with their business and regulatory requirements.

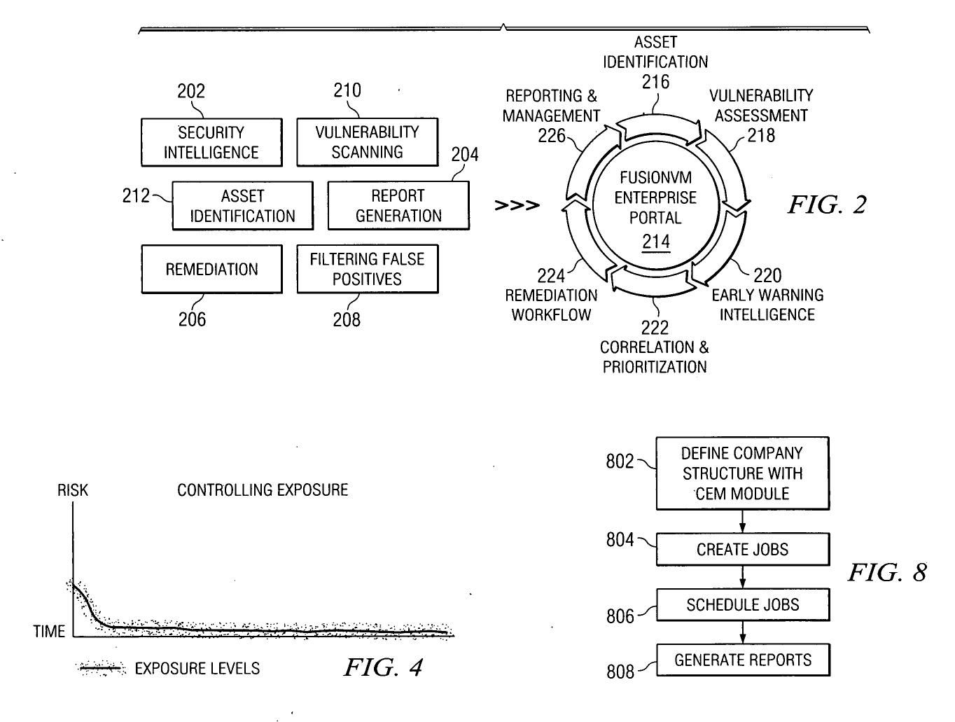

Referring now to FIG. 2, there is illustrated the manner in which Applicants' invention transitions from a disparate group of technical functions to a more automated and cohesive full life cycle approach. The separate functionalities of security intelligence gathering 202, report generation 204, remediation 206, filtering false positives 208, and asset identification 210 are integrated around an enterprise portal 214. An enterprise portal 214 is a management platform that includes a number of integrated components including an asset management module 216 supporting continual discovery, asset inventory, business attributes, categories, sorting and grouping. The vulnerability assessment module 218 determines system vulnerabilities including limiting false positives, managing thousands of devices, robust scheduling management, and external facing or internal infrastructure. An early warning intelligence module 220 supports proactive elimination of emerging vulnerabilities by correlating against assets and streaming fixed instructions to responsible parties. A correlation and prioritization module 222 implements a tailored process delivering information on business impact based on taxonomy or scoring, remediation, and prioritization. A remediation and workflow module 224 provides detailed solutions, management of the remediation process and user accountability, converts information into action and converts action into measurable units. A reporting and management module 226 delivers relevant business context and appropriate technical contacts to various report viewers.

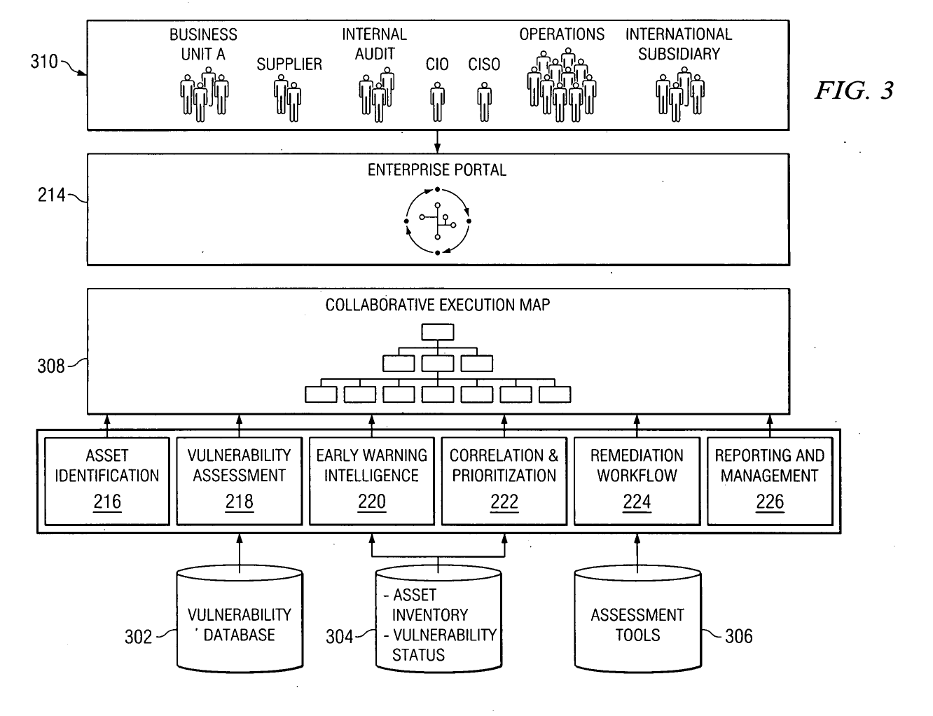

Referring now to FIG. 3, there is illustrated a functional block diagram of the system and method for vulnerability assessment according to the present invention. The system utilizes information stored within a number of databases to provide vulnerability assessment to a consumer. The vulnerability database 302 provides detailed information on various known vulnerabilities that exist within the network environment. An asset database 304 includes information with respect to the asset inventory of a particular consumer, the business attributes of the consumer and the vulnerability status of the consumer. This would provide information such as all of the IP addresses assigned to a particular entity and the characteristics associated with these IP addresses. The asset database 304 would also contain the known problems with this network that have been previously detected based upon the type of inventory and attributes indicated for the entity. Finally, an assessment tools database 306 provides the various tools necessary for testing an entity's network in order to detect known vulnerabilities within the network. All of the data and information provided by the databases 302, 304 and 306 are utilized by the asset identification module 216, vulnerability assessment module 218, early warning intelligence module 220, correlation and prioritization module 222, workflow management module 224 and reporting and management module 226 as described previously with respect to FIG. 2.

Access to and organization of all the data within the databases 302, 304 and 306 and use of the data provided by the various modules may be organized and controlled using the collaborative execution map (CEM) 308. The collaborative execution map 308 enables a user to dynamically establish the priorities and organization of the vulnerability management system. The collaborative execution map 308 provides a flexible framework that enables an enterprise business process to apply vulnerability management that is customizable according to a particular organization's environment. Each participant 310 in the process, which may belong to different part of the enterprise, has a personalized view of the vulnerability management process via portal 214 that is established within the collaborative execution map 308 based upon his placement in the business taxonomy, asset responsibilities and permissions. For example, an organization's chief information officer (CIO), regional information technology (IT) manager, and unix administrator would each have a particular view of the organization's taxonomy and technical vulnerability management processes based upon their placements, responsibilities and permissions. Each of these would be established through the collaborative execution map 308. Their views could therefore differ, possibly substantially. As contrasted with a system of periodic checkups, a continuing reduction in exposure achieved by implementing an enterprise-wide taxonomy-based vulnerability administration system enables continuous reductions in risk levels over time as illustrated in FIG. 4.

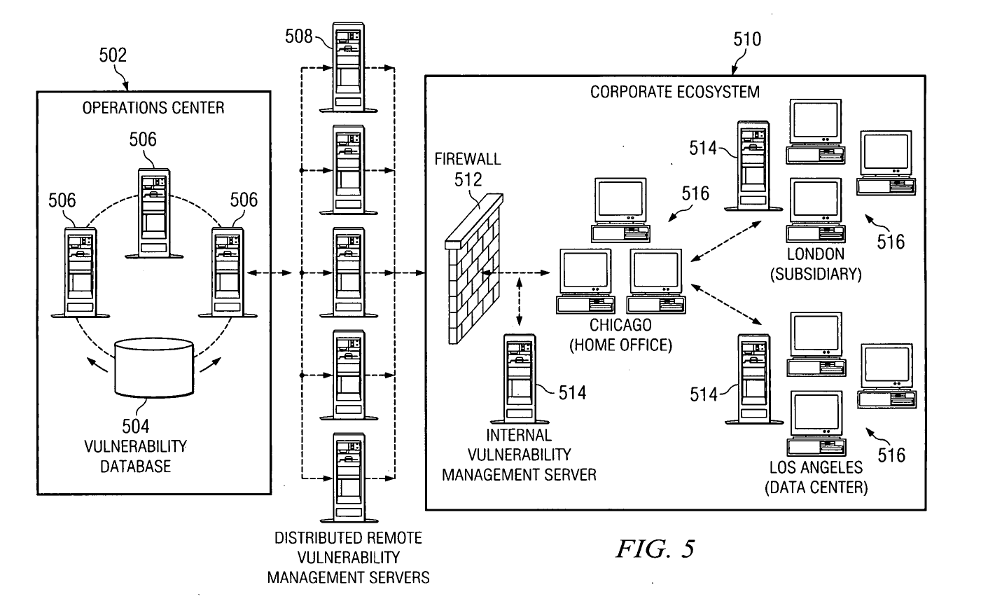

Referring now to FIG. 5, there is illustrated a distributed infrastructure for carrying out technical vulnerability management processes. The vulnerability management process can be provided as a service or as a fully delivered product. A central operations center 502 includes a vulnerability database 504 and a number of servers for providing overall control of the vulnerability management functionalities. (Controller, portal etc.) A series of distributed remote vulnerability management servers (VM Servers) 508 enable the vulnerability management system to externally test and extract information from a corporate ecosystem 510. These tests would occur through the firewall 512 of the corporate ecosystem 510 in order to simulate external attacks. Internal vulnerability management servers (VM Servers) 514 are used to access internal networks 516. The internal servers 514 may be pre-configured to facilitate their efficient installation. A plurality of distributed remote vulnerability servers 508 and 514 test the corporate ecosystem 510 using testing tools based on the information contained in the vulnerability database 504. Size and network topology determine the number of internal servers 514 needed. New and updated vulnerability testing tools can be automatically pushed out to the external 508 and internal 514 management servers as they become available, on a daily, or even more frequent basis.

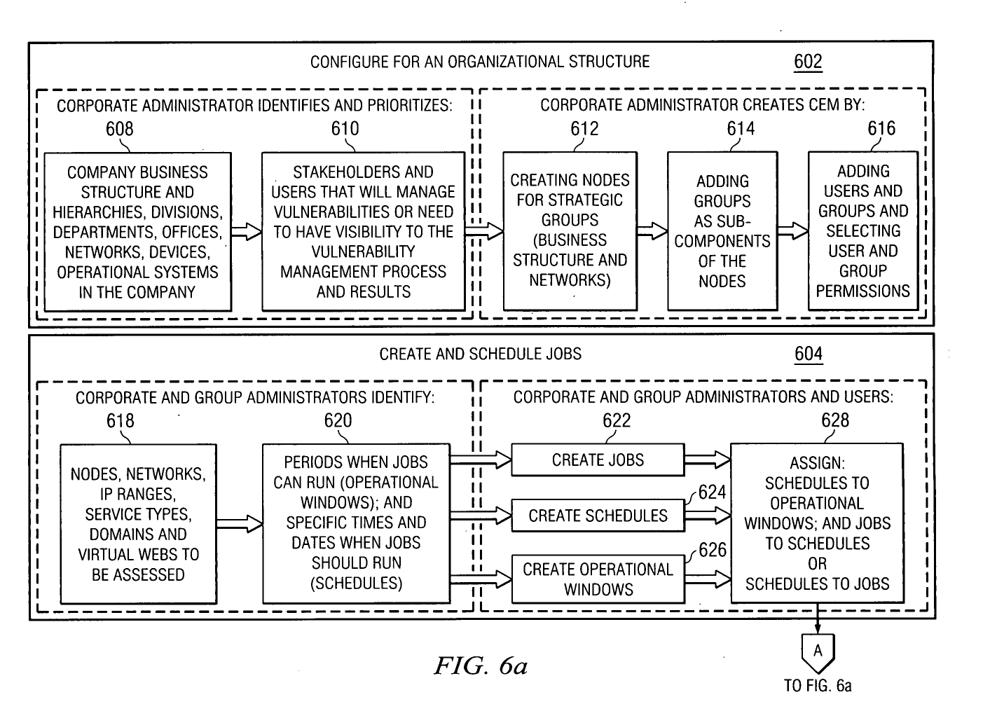

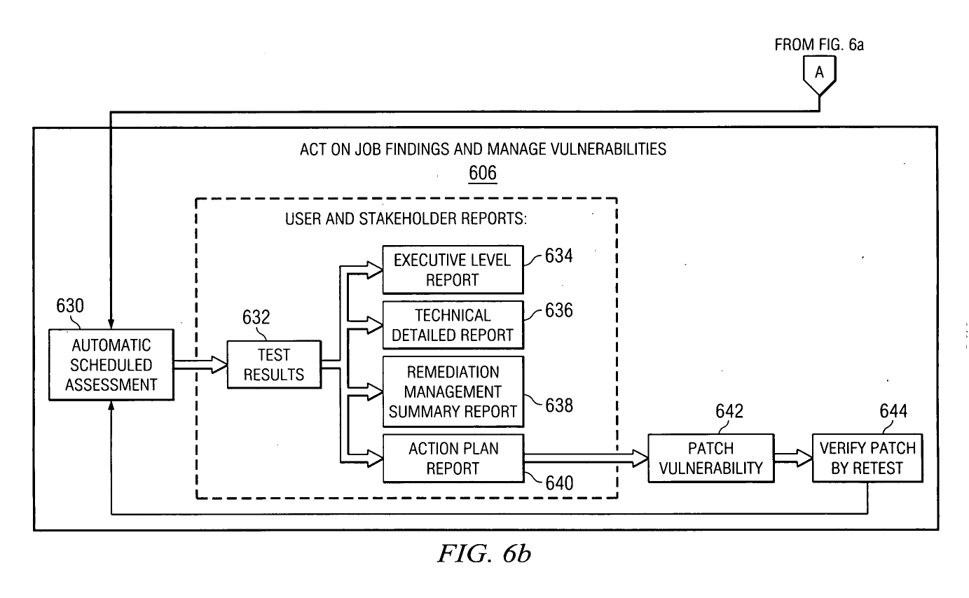

Referring now to FIG. 6, there is illustrated the process by which the present system may be used at an organizational level to manage an entity's network vulnerabilities. There are three main user objectives for the system. Configuring the system for a specific organizational structure at 602. This involves the designation of employee and group roles, authorities, and responsibilities; and integrating them into an organizational security process to provide an accountability structure. Next, the user must create and schedule jobs for the assets of the organizational structure at 604. Finally, the organizational entity must act upon the job findings and manage the system vulnerabilities at 606. The process of configuring the system for an organizational structure involves the corporate administrators first identifying and prioritizing the structure of the company. At 608 the company's business structures and hierarchies are determined. This involves dividing the company into various divisions, departments, offices, networks, devices, or operational systems within the company.

Next, the individuals that are responsible for managing various vulnerabilities within an organizational structure are provided at 610 with the ability to view the vulnerability management process and its results. This will provide for those responsible for managing various vulnerabilities to have the tools necessary to determine the state of vulnerabilities and the improvements caused by implemented policies. Once these determinations have been made, the system utilizes its collaborative execution map (CEM) which will be more fully discussed herein below to create nodes at 612 for the various business structures determined at 608. The various groups may be added as sub-components to existing nodes of the system wherein the sub-groups comprise nodes that are managed as sub-units of previously recited nodes to the n layer as needed. Finally, particular users and groups may be provided under designated nodes and these individual users and groups may be provided permission with respect to the system as to nodes which they may be able to view vulnerabilities or alter and in general manage the vulnerability management process.

A job is defined as an assessment of a specific node, group, network, Internet protocol range, domain or virtual web. Each job must run according to a schedule or activated on demand. Jobs may run using schedules within an operational window if required. Schedules specify the date and time for a job to start while operational windows identify specific time periods and dates available for a scheduled job to run. This limits the time when a schedule can run. If a job cannot complete within a specific operational window, it continues in the next available operational window. When an operational window is not specified, a schedule runs until complete.

During the process of creating and scheduling jobs at 604, there must be created at 618 the nodes, networks, IP ranges, service types, domains and virtual webs that are required to be accessed and tested by the system. A determination of periods when jobs may be run is made at 620. This involves determining operational windows when testing is possible. After determining operational windows, particular schedules may be determined by selecting specific times and dates when a job should be run. Once the operational windows are identified, the jobs can be created at 622, the schedules can be created at 624 and the various operational windows in which the schedules may occur can be created at 626. The created job schedules and operational windows are manipulated to assign schedules to operational windows and jobs to schedules or to schedule jobs at 628.

The performance of these operations will lead to the process of acting on various job findings at 606 wherein an automatically scheduled assessment at 630 will produce various test results 632. These generated test results 632 are used to generate a variety of reports that can be provided at different levels of detail depending upon the entity to which the report is to be routed. These reports consist of, for example, an executive level report 634, a technical detailed report 636 and remediation management summary report 638 and an action plan report 640. Executive level reports 634 provide graphical and tabular vulnerability trends by risk level, summaries of content vulnerabilities, root causes, vulnerability impact and skill level summaries. Technical detail reports 636 include both high level summaries and in-depth information needed to analyze specific problems, determine business or IT security priorities, mobilize staff for remediation and verify device profiles. Remediation management summary reports 638 reveal the success rate of remediation by showing how quickly vulnerabilities are repaired, highlight reoccurrences, and expose new vulnerabilities that have emerged since the previous assessment that have not yet been fixed. Action plan reports 640 provide repair tickets for each identifiable IP address with a one line description of vulnerability and repair instructions. On occasion vulnerabilities are not repairable, such as when software or equipment has been disconnected. These vulnerabilities may be filtered or removed from reports. The differing types of reports will be more fully discussed hereinbelow. The action plan report 640 may be used to provide various patch vulnerabilities at 642 and then generate a retest at 644 to verify the patch. A full patch management assignment and work flow is provided as a separate module.

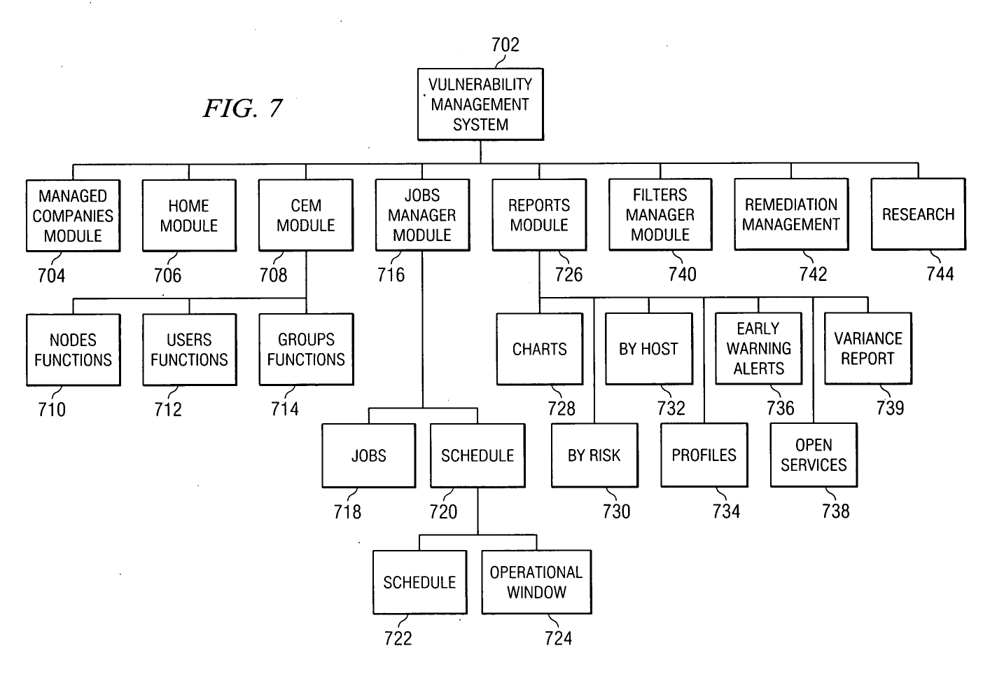

Referring now to FIG. 7, there is illustrated a functional block diagram of the system for managing network vulnerabilities including each of the functional modules associated with the system. The system provides a graphical user interface via a computer to enable the management of a vulnerability management process. Via a main portal of the vulnerability management system 702, an administrator (user) has the capability to interact with a number of functional modules providing various tools for managing or reporting on the system for network vulnerability management. The managed company module 704 allows individuals to create and modify companies within the vulnerability management system 702. The only users who may view the managed companies module 704 are those with “company management” rights. The nodes of this module help to organize or manage companies. The home module 706 is the first page a user sees and provides a log-in prompt along with news and advisory feeds provided from the vulnerability management system provider. Once the user signed into the portal the home module 706 includes a number of functionalities including the provision of sign-in functionalities, security news, security advisories and graphs which report summaries of the impact of vulnerabilities and vulnerabilities by risk based on the permission of the user in the system.

The collaborative execution map (CEM) module 708 enables a user to uniquely configure the process management of enterprise systems vulnerabilities. The CEM module 708 provides a flexible folder-based system for organizing and managing the relationship between users and the assets they are responsible for, as well as for determining what product's features and functions are accessible to individuals. The CEM module 708 provides a process framework that defines what an individual user can do and see from their portal view. The folder system can be nested to create a tree model that accurately reflects the organization's operating environment to the n layer. Organizations can create and manage assets, view reports and alerts, create and manage remediation assignments, all through the backdrop of their business as defined by the tree structure established in the CEM module 708. The tree structure enables clients to adjust the vulnerability management process to their changing environment by simply dragging and dropping the map elements of assessment jobs, users, schedules, etc.

The following are the general features of the CEM module 708. Reports are based on the tree structure of the organization established via the CEM module 708 resulting in a dynamic reporting framework that is unique to the operating structure and risk management requirements of a particular organizational entity. Users' and groups' areas of responsibility are based on where they are attached to the CEM tree structure. This creates personalized portal content for each user based on the assets assigned to them and their roles in the process. Cascading permissions are established using a template approach through inheritable permissions or can be configured for individual components. Each function of the site carries a view, edit, add or delete capability. This flexibility allows administrators the ability to easily create users who have as much or as little involvement with the process as desired. Users can also be granted rights to grant permissions to those on their system to reflect shared vulnerability management responsibility.

The CEM module 708 supports creation and modification of organizational hierarchies of nodes (work place units such as departments and divisions) and instances of users and groups, assignment of portal security privileges, and assignment of users and groups to the organizational hierarchy. Organizational hierarchies can be associated with physical organization structure, business functionality, team accountability structure, machine type, networks, asset criticality, auditing and compliance functions or any other logical grouping. Nodes can be defined as specific workplace units, such as company locations, departments, divisions, networks or groups of equipment. Functionalities of the CEM module 708 may be broken down into node functions 710, user functions 712 and group functions 714. The node functions 710 enable a user to create and modify nodes, users and groups, assign users to groups and nodes with cascading permissions and create and modify user group privileges and authentication permission. The user functions 712 enable an individual to create and modify user privileges and authentication privileges. The group function 714 enables a user to add and delete groups and to create and modify group privileges and authentication permissions.

The jobs manager module 716 allows users to create, modify and delete jobs. The jobs manager module 716 also allows users to assign jobs to a schedule, establish job permissions and easily monitor the settings in a tabular format. A job is defined as an assessment of a specific node, group, network, Internet protocol IP range, domain or virtual web. The jobs manager module 716 allows users to create assessment/scan jobs for assets in folders they are authorized to work on. The jobs manager module 716 conducts assessments, at predetermined schedules, using either external or internal servers, which identify the assets and profiles them including device, ports, operating system, services, application, version and vendor. The jobs manager module 716 evaluates both active and inactive IP addresses within a given range, detects wireless access points and catalogs network devices such as firewalls, routers, switches, hubs, servers and desktops. The jobs manager module 716 includes a job detail and permissions functionality 718 supporting the creation and modification of jobs. Using this functionality a job may be assigned a node in the user defined organization structure, to an IP address or IP address range or to virtual webs.

The schedules functionality 720 enables users to set predetermined times for jobs to be automatically run. Scheduling is flexible and ranges from nonrepeating, one time assignments to annual, quarterly, monthly, bi-monthly, weekly, daily ongoing assignments, as well as other user-created ongoing time-period increments. Multiple schedules may be attached to a particular job. Multiple jobs may also be attached to a schedule. The schedules module 720 enables the user to use schedules, view all jobs affected by schedules, create or edit schedules, or delete a schedule. The schedules module 720 allows users to define job schedules for organizational nodes and define the time and date when jobs can occur on a company's network. The jobs functionality 718 enables a user to view all jobs, stop or pause a running job, initiate a scan by a job, create or edit jobs, configure a scan or delete a job. In addition to creating a schedule 722, the schedule functionality 720 defines operational windows 724. Operational windows 724 restrict jobs/scans to function only within the operational window of time. Jobs that do not finish scanning a set of assets within the operational window will resume the test once the operational window opens again. A number of capabilities are available within the operational windows module 724 including viewing of all operational windows, viewing of schedules affected by an operational window, creation or editing of an operational window and deletion of an operational window.

The reports module 726 allows authorized users to view test results of specific jobs in an organizational nodes. The CEM module 708 determines what stake-holders can see using the reports module 726 based upon the permissions assigned to a particular user. The reports module 726 enables an organization to dynamically review reports based upon a business framework established in the CEM module 708. Individual asset owners have report information personalized for them based upon their individual permissions, permissions associated with their roles and assets they are responsible for. Reports can roll up or drill down to provide visibility from any vantage point on the established tree structure. The reports module 726 is able to provide a number of report types. The charts report 728 provides current information on the impact of various vulnerabilities, vulnerabilities by a particular risk category and vulnerabilities by group causes. The charts report 728 may additionally provide trending information related to vulnerabilities by risk, the system scan, user defined time range and user defined testing periods. The by risk report 730 provides information on discovered vulnerabilities sorted by risk and may contain information related to risk level, vulnerability, accounts and details. The details may include such information as exposure name, publish date, CVE number, risk level, skill level, likelihood, root cause, business impact, description, concern, solution and references. Vulnerabilities may also be sorted via locations providing location information such as node, job, IP address, host name, port number, critical details and notes.

The by host report 732 provides information at the IP address level with a roll-up summary report card including information by node on vulnerabilities, vulnerabilities by risk, jobs and risks. The information could also be grouped according to IP address, host name, risk factor, critical details or links to vulnerability details such as exposure name, publish date, CVE number, risk level, skill level, likelihood, root cause, business impact, description, concern, solution and references. Profile reports 734 provide profile information for active IP addresses. The information included in the report may include an IP address, a host name, operating system fingerprint, ID method, open service, port, protocols, details such as banners, application version and patch level or links to details such as service name, default port, protocol, description, function and comments. The early warning alerts report 736 indicates new vulnerabilities announced on the Internet having general application affecting a very wide spread technology or specific applications correlated to particular IP addresses based on a most recent scan. The open services report 738 enumerates open services and details problem locations that have been discovered. Known services such as service name, description, count, details may be provided. Unknown services will identify the port the service is identifying with and the IP the port belong to. The variance report 739 shows the changes to the number of vulnerabilities from a previous scan to a new scan showing what vulnerabilities were fixed, what vulnerabilities were not fixed and what new vulnerabilities were found in the last scan.

The filter manager module 740 allows authorized users to issue filters to vulnerabilities so they will not appear on reports. The Filters Manager 740 provides a mechanism to filter selected vulnerabilities out of ongoing reports whether they are vulnerabilities that cannot be fixed, are acceptable risks to the enterprise or are false positive results. Vulnerabilities that have been filtered no longer appear in the reports for the duration of the filter. This reduces the redundancy of reanalyzing known non-issues. All vulnerabilities that have been filtered are systematically itemized for auditing purposes. The Filters Manager 740 logs the original author of the filter, the reason for the filter, filtered date as well as expiration date. All modifications to all filters are also recorded in the filter's history. The CEM module 708 determines what stake-holders can do using the filter manager module 740 based upon the permissions assigned to a particular user.

The remediation manager module 742 allows authorized users to assign vulnerabilities for remediation to themselves or their teams, view the vulnerability process and ticket history. The CEM module 708 determines what stake-holders can do using the remediation manager module 742 based upon the permissions assigned to a particular user.

The research manager module 744 allows authorized users to search the vulnerability database for the current vulnerabilities available to the system. The CEM module 708 determines what stake-holders can do using the remediation manager module 744 based upon the permissions assigned to a particular user.

Referring now to FIG. 8, there is illustrated a flow diagram illustrating the manner in which the vulnerability assessment system of the present invention may be used to manage the vulnerabilities of a particular organizational entity. Initially at step 802, the CEM module 708 is used to define the company structure using the nested tree structure described previously herein. From this defined tree structure established within the CEM module 708, jobs may be created for execution on nodes and entities within the tree structure at step 804. Once these jobs have been created, they may be scheduled for operation at step 806 either at any defined time or within an operational window defined by the jobs manager module 716. Once the jobs have been created, reports are generated at step 808 using the reports module 726 such that those responsible for the network's vulnerability management may utilize these reports to correct detected vulnerabilities. Utilizing the reports a user can measure the effectiveness of the vulnerability management process and verify compliance with business and regulatory requirements in 810.

Referring now to FIG. 9, there is illustrated a view of the graphical user interface provided by the CEM module 708. The graphical user interface provides a user interface for a vulnerability management process administration having an organization taxonomy which is hierarchical and uniquely definable according to a particular organizational entity. A collapsible and expandible tree 902 is shown on the left side of the screen to provide a graphical display of the organizational structure. The tree can expand to n layers as needed. The organization units within the tree 902 include locations, departments, divisions, servers, computers, IP addresses, etc. and appear as folders 904 in the tree structure. The folders have attached thereto icons 906 representing individual users 906a or groups 906b of users. The structure tree 902, the fundamental navigation framework for the portal, appears on other portal screens for the other modules described herein. This provides the ability to activate any of the taxonomy folders 904 to give a user the ability to change his vantage point for the information appearing in the display window 908 on the right showing the specific organizational segment under review. The user listings 906a and group listings 906b are also displayed corresponding to organizational units which are selected on the tree. Organizational units can be added with the add node button 910, users can be added using the add new user button 922 and then a user may be added to a group. Users and groups can be displayed on the CEM, or hidden from the CEM by activating buttons 912 or 914. This is done for example to quickly verify the accountability of people responsible for a particular folder in the situation that a folder has a poor vulnerability scoring. Editing of a particular element settings can be initiated with the edit button 918 associated with that element. Similarly, a particular element can be deleted using the delete button 920 by the associated element.

Thus, as can be seen in the tree structure 902, the organizational entity FGS Inc. has been broken down into a number of sub-folders identified as Fiction Healthcare Co., Fiction Financial Svcs. and Fiction Group Insurance. The Fiction Group Insurance node has been further broken down into nodes for Phoenix Data Center, Development Lab, Sales Office and Network Ops. The Phoenix Data Center node has further been broken into folders for Web Servers and Routers and an individual identified as “Anderson, John.” Thus, the tree structure is defining the desired organization of the entity and the individuals and groups associated with particular nodes they are responsible for.

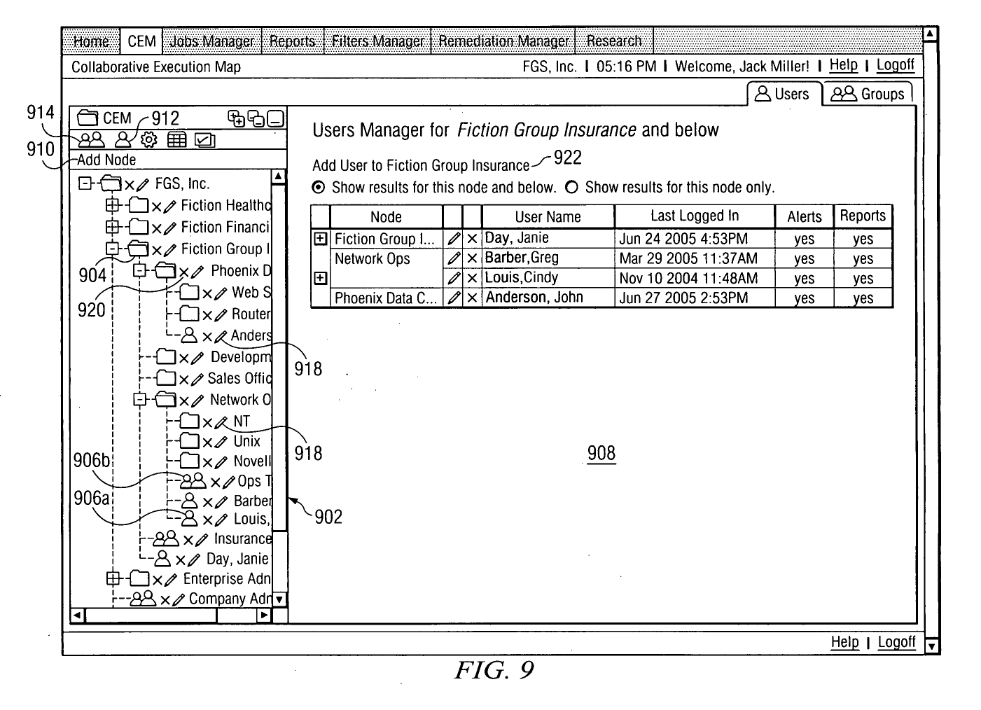

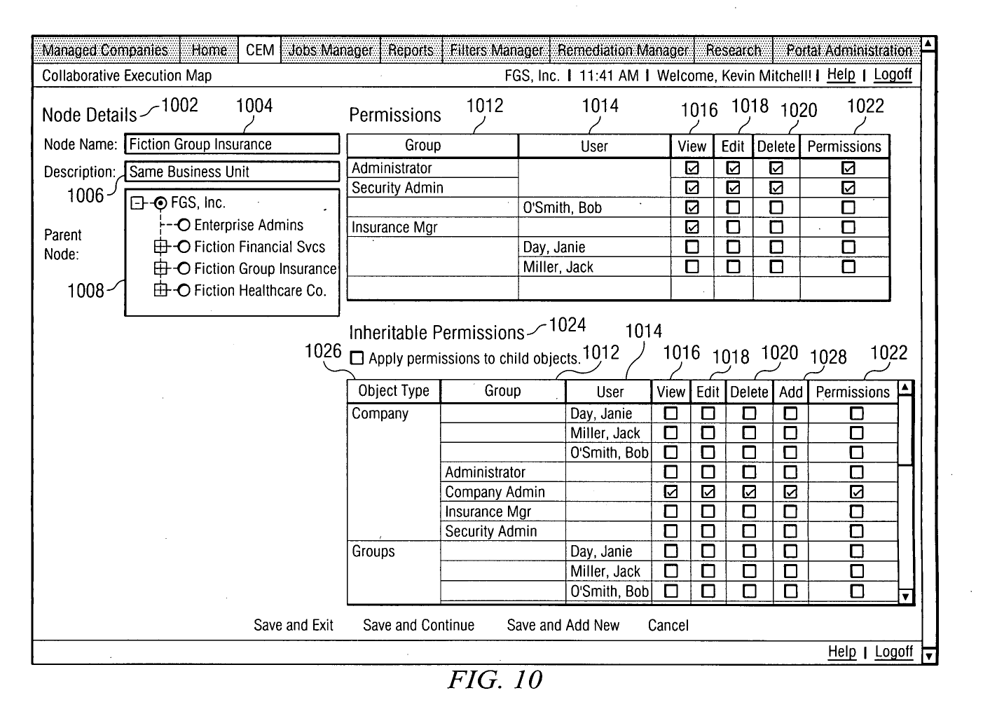

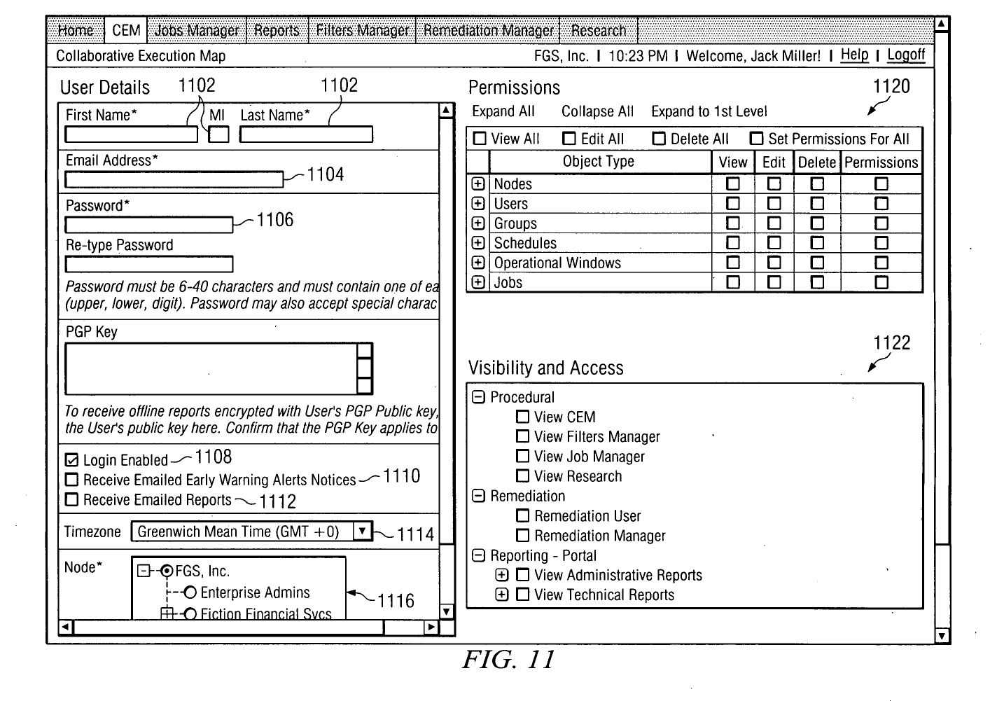

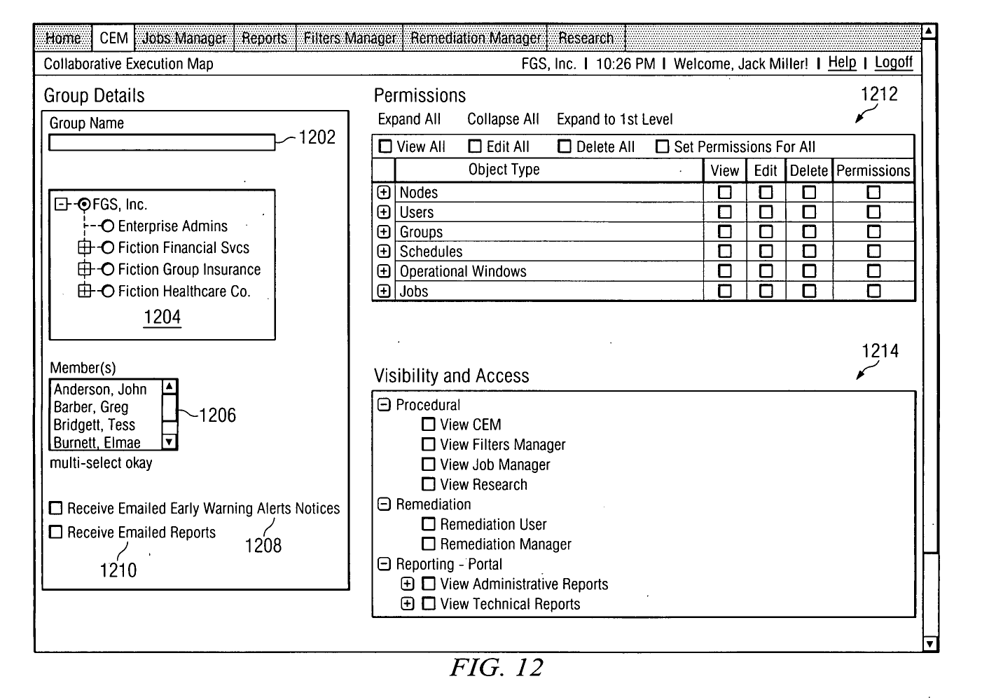

Referring now to FIGS. 10-12, there are illustrated the user interfaces for editing taxonomy nodes (FIG. 10), users (FIG. 11) and groups (FIG. 12). Each of these screens would be accessed by clicking on the appropriate edit button 918 associated with a particular node, user or group. Depending upon the entity beside the particular edit button 918 pressed, the associated node, user or group screen would appear. The nodes editing screen illustrated in FIG. 10 includes the node details title 1002 including the node name 1004 assigned by a user which may be edited, a description 1006 associated by the user which may also be edited and the parent node 1008 to which the node is connected. The node detail also includes a permissions section 1010 having the permissions assigned to particular groups of users 1012 and individual users 1014 attached to the node. The permissions assigned to associated groups and users include view 1016, edit 1018, delete 1020 and permissions 1022. Each of these may either be checked or unchecked to provide or remove the permission from the group or user within the node details screen.

The view permission 1016 provides the ability for a user or group to see a set of nodes they are attached to and only those nodes within the portal. This is the most basic permission level and is required if other permission types are assigned. If a user or group has been granted any other permission type to a node, such as edit permissions, the view rights will be assigned by default. The edit permission type 1018 allows a user or group to make modifications to an existing node. If edit permissions are not granted, the user or group will be unable to access the item edit page or view the edit button 918 for the node. If edit permissions are granted, view permissions are granted by default. The delete permission type 1020 allows a user or group to remove a node. The ability to remove a node is indicated by the delete button 920 next to the node. If delete permissions are granted, view permissions will be granted as well by default. The permission type 1022 allows a user or group the ability to set other users and their functionality in the folders they have permission to access. The right to provision other user or group is indicated by the ability to see the permissions edit table 1010 within the node details screen. If a user or group has the right, then edit and view permissions are granted for the object as well.

The inheritable permissions edit table 1024 allows an administrator to set permissions for object types 1026 for current and future users and groups. Inheritable permissions are accessed via any node if the user has permission. When seeing these permissions, the administrator provides a user 1014 or group 1012 the ability to manage all new objects created and/or existing objects attached to the node being edited and/or its children. The permissions include those discussed above with respect to the permissions table 1010 including view 1016, edit 1018, delete 1020 and permissions 1022. Additionally, the add permissions type 1028 provides the ability to add an object to a user or group. All new objects are attached to users and groups and the users and groups have permission to folders on the tree based on permissions granted in 1010.

The users details edit screen illustrated in FIG. 11 includes fields 1102 for entering a user's first, middle and last names. An e-mail address field 1104 provides a location for entering a user's e-mail address, and a password field 1106 provides a location for entering the user's password. The login enable field 1108 enables the user to be authorized to log in to the system. A receive e-mail rapid alert notices field 1110 enables the user to be authorized to receive rapid alert notices via e-mail, and a receive e-mailed reports field 1122 enables the user to receive an encrypted PDF report via e-mail. The time zone of the user may be established in the time zone field 1114, and the node with which the user is associated may be indicated in field 1116. If a user is associated with a group he will automatically receive the group inheritable permissions plus any other permission he receives from the following description. An editable permissions table 1120 enables the user to be granted permissions to object type for only the current nodes in 1116 according to the various assignable permissions discussed previously. The editable roles table 1122 enables the user to be provided with selectable views and operation of all tabs, or only a subset of the tabs like CEM, filters manager, and job manager, reports and other functionality as described in FIG. 7.

The groups details edit screen illustrated in FIG. 12 includes a group name field 1202 providing a location for indicating the name of a group. The node field 1204 enables an indication of the node with which the group is associated. A member field 1206 includes a listing of all members within a particular group. The receive e-mail rapid alert notices field 1208 and the receive e-mail report field 1210 enables a group to receive these particular types of notices and reports via e-mail. The editable group permissions table 1212 and 1214 provides a manner for groups to be granted various permissions types as discussed previously for users. Each group may have permissions to operate on different nodes with the identified objects functionality.

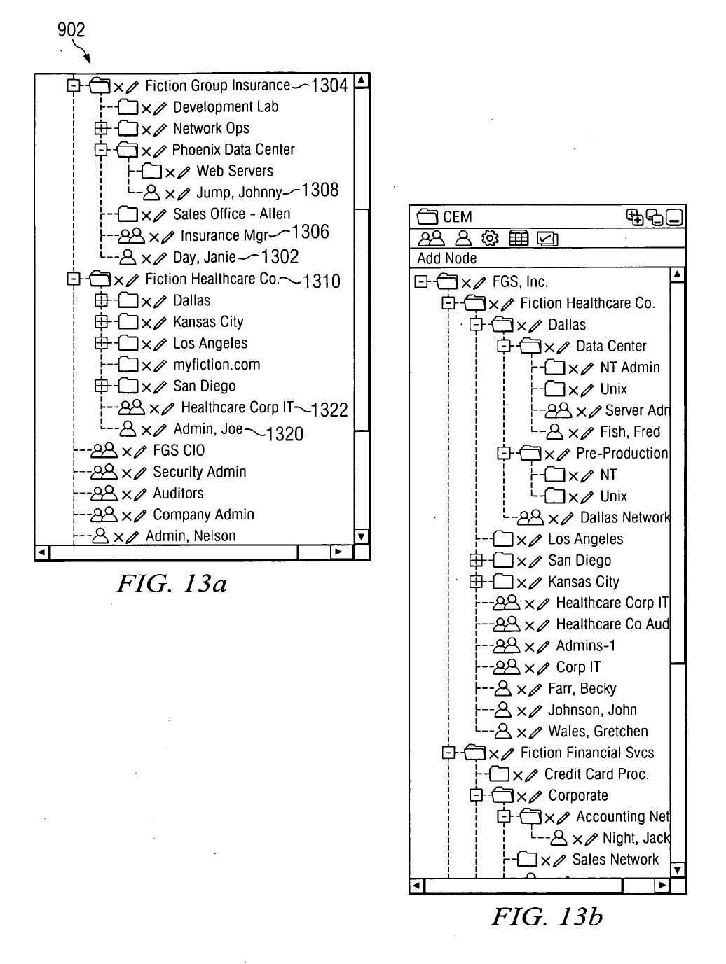

Referring now to FIG. 13a, there is illustrated a further example of a tree structure 902 that may be associated with a particular organizational entity. When assigning permissions associated with particular nodes, groups and users, the flow of permissions within the tree structure 902 would occur in the following manner. Without considering group membership, Janie Day 1302 is attached to the node Fiction Group Insurance 1304 and is granted permission to see all the folders and users under Fiction Group insurance including Insurance Mgr. group 1306 and the user Johnnie Jump 1308. Johnnie Jump 1308 can see only folder Phoenix Data Center and below if he has view permission but cannot see or have any access to Janie Day 1302 or her folders. Janie Day 1302 cannot see anyone attached to the node Fiction Healthcare Co. 1310 or its associated folders.

If an administrator with appropriate authority set permissions for Janie Day 1302, Janie Day would see Insurance Mgr. 1306 and Johnnie Jump 1308 in the permissions table when editing Janie Day, the administrator would also be able to set permissions for Janie Day 1302 to view, edit, delete or set permissions on the Insurance Mgr. group 1306 or Johnnie Jump 1308. However, if editing Johnnie Jump 1308, neither the Insurance Mgr. group 1306 or Janie Day 1302 would be in the list of available items in the permission table associated with Johnnie Jump 1308, and the administrator would be unable to set permissions for Johnnie Jump to view Janie Day 1302 unless he moved Johnnie Jump 1308 to the same or parent node as Janie Day. A user's or group's placement in the CEM tree structure 902 affects their ability to see other users, groups, nodes, jobs, schedules, operations windows, and report data. As a general rule, a user or group only has access to all children below its location or to sibling objects attached to the same node providing they have view permissions.

An object may be moved by dragging and dropping within the tree structure 902. If Joe Admin 1320 were moved from the node Fiction Healthcare Co. 1310 to the node Fiction Group Insurance 1304, Joe Admin 1320 would gain access to Janie Day 1302 and Johnnie Jump 1308 but would lose the ability to access the group Healthcare Corp. IT 1322. This would include losing the ability to manage the group Healthcare Corp. 1322 or any object at or below the node Fiction Healthcare Co. 1310. When moving items, a warning is given to the mover as to what functionality may be lost and it must be confirmed by the mover before finalized by the system. The mover may choose to cancel or accept the move at this point. Another example is illustrated in FIG. 13b.

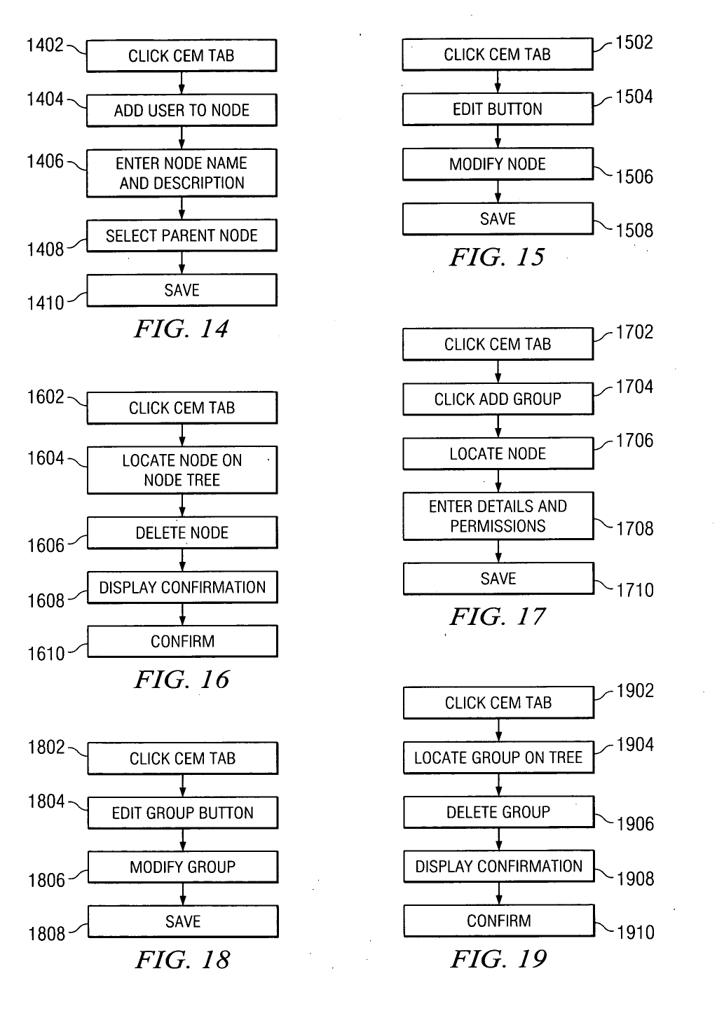

Referring now to FIG. 14, there is illustrated a flow diagram describing the process for adding a node within the tree structure 902 of the CEM module 708. A user initially clicks on the CEM tab within the portal interface illustrated in FIG. 9. Next, the add user to node button is actuated to enable entry of the new node. This will cause the node details and permissions screen (FIG. 10) to appear. The user enters the node name and description information within the node name field 1004 and description field 1006. A parent node is selected at step 1408. The newly created node is saved at step 1410.

Referring now to FIG. 15, there is illustrated the process for modifying a node within the tree structure 902 of the CEM module 708. The process is initiated by clicking on the CEM tab at step 1502. The edit button associated with the node is actuated at step 1504 causing the node details and permission page (FIG. 10) to appear. The node details and permissions are modified as desired at step 1506, and the modified node information is saved at step 1508.

Referring now to FIG. 16, there is illustrated a flow diagram of the process for deleting a node from the tree structure 902 of the CEM module 708. The process is initiated by clicking on the CEM tab at step 1602 of the main portal page. The user locates at step 1604 the node desired to be deleted on the node tree 902. The node is deleted at step 1606 by clicking on the delete button 920 associated with the located node. Responsive to pressing of the delete button 920, a confirmation is displayed at step 1608 asking the user if they are certain they wish to delete the particular node. If so, the user confirms the deletion at step 1610.

Referring now to FIG. 17, there is illustrated a flow diagram of the process of adding a group to the tree structure 902 of the CEM module 708. The user accesses the CEM module 708 by clicking on the CEM tab at step 1702 on the main portal page. The user clicks on the add group button at step 1704 and locates at step 1706 the particular node to which the group is to be added. This causes the group details and permission page (FIG. 12) to be opened, and the user enters the group details and permissions at step 1708 within the open page. The user saves the entered group information at step 1710.

Referring now to FIG. 18, there is illustrated the process for modifying a previously entered group. The modification is initiated by clicking on the CEM tab at step 1802 of the main portal. The user clicks on the edit button 918 at step 1804 associated with the group to open the group details and permissions page (FIG. 12). The user modifies the details and permissions for the group at step 1806 and saves the modified details at step 1808.

Referring now to FIG. 19, there is illustrated the process for deleting a group from the tree structure 902 of the CEM module 708. The process is actuated by clicking at step 1902 on the CEM tab of the main portal page. The particular group to be deleted is located at step 1904 on the tree structure 902. The group is deleted by clicking at step 1906 on the delete button 1920 to the left of the selected group. A confirmation window is displayed at step 1908 responsive to the deletion, and the user may confirm the deletion at step 1910.

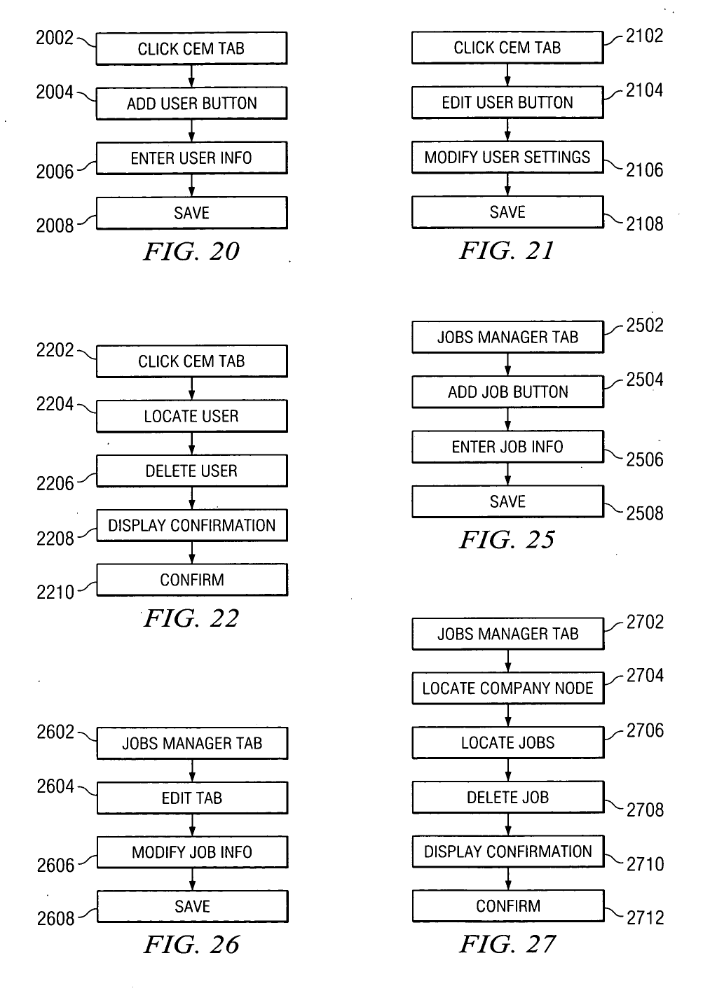

Referring now to FIG. 20, there is illustrated the process for adding a user to a group or node. The process is initiated by clicking on the CEM tab at step 2002 of the main portal page. The user clicks on the add user button at step 2004 causing the user details and permissions page (FIG. 11) to appear. The administrator enters the appropriate details selecting nodes or groups as needed and permission at step 2006 for the user and saves the user information at step 2008.

Referring now to FIG. 21, there is illustrated a flow diagram of the process for modifying a user's settings wherein the process is initiated by clicking at step 2102 on the CEM tab of the main portal page. The administrator selects the edit button 918 at step 2104 associated with the user to be modified causing the details and permissions page (FIG. 11) of the user to appear. The administrator modifies the user settings at step 2106 within the user details and permissions page and saves the modified details at step 2108.

FIG. 22 illustrates the process for deleting a user from a particular group or node. The administrator accesses the CEM module 708 by clicking on the CEM tab at step 2202 of the main portal page. The user to be deleted is located at step 2204 within the tree structure 902 and the delete button 920 associated with the user is selected at step 2206 to delete the user from the associated group or node. A confirmation is displayed at step 2208 to confirm the desire to delete the user, and a confirmation is provided at step 2210.

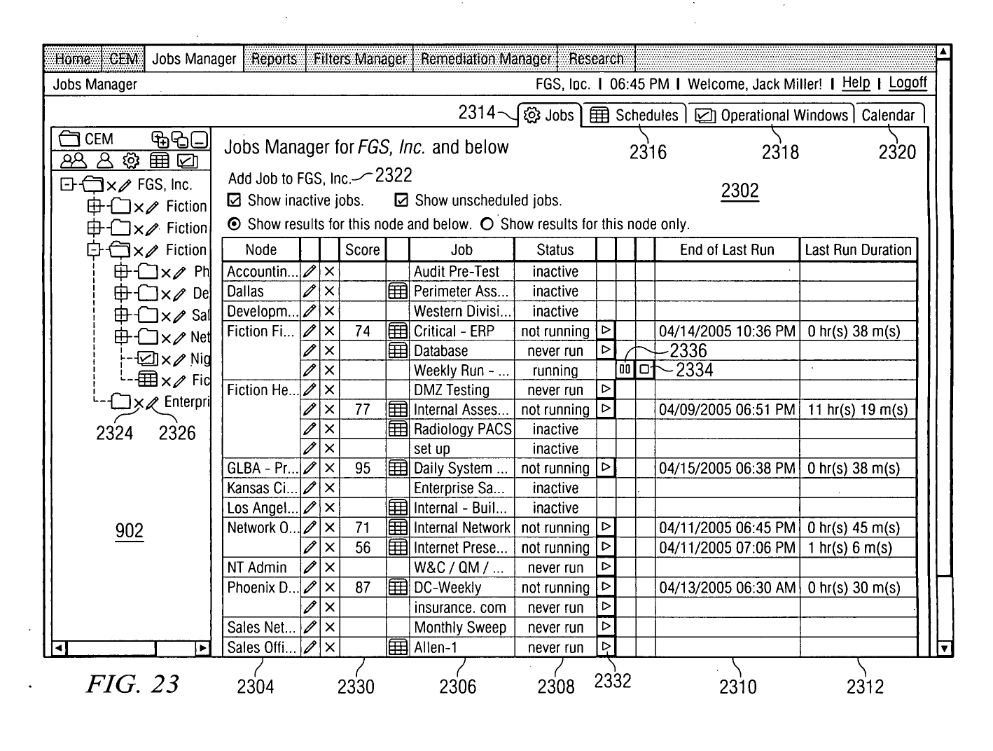

Referring now to FIG. 23, there is illustrated the graphical user interface associated with the jobs manager module 716. The main page is primarily a display of job details and includes the collapsible/expandible tree structure 902 on the left of the screen to provide a graphic display of the organizational structure previously established in the CEM module 708. Job details for each node are selected by clicking on the appropriate node name. Once a node is selected, a tabular display 2302 provides the ability to view results for this node and all nodes contained below the node or results for the selected node only. The table includes a node column 2304 listing the associated nodes, a job column 2306 listing the job associated with the node, and a status column 2308 indicating whether the job is presently active or not running. Additional columns provide an indication of the ending point or last run of the job 2310 and a column 2312 indicates the duration of the last job run and other columns show node test scorings 2330 as well as providing buttons icons to activate 2332, stop 2334 or pause 2336 jobs on demand. The jobs tab 2314 provides a listing of the jobs for a selected node in the tree structure 1902. A schedules tab 2316 allows a display of the schedule of various jobs for a node. The operational windows tab 2318 provides the operational windows for which a node may have jobs run on a network, and a calendars tab 2310 provides an overall calendar view of jobs, operational windows and schedules. The add jobs button 2322 enables jobs to be added to the process for a selected node. The delete button 2324 enables the deletion of jobs, and the edit button 2326 allows for the editing of jobs within a node.

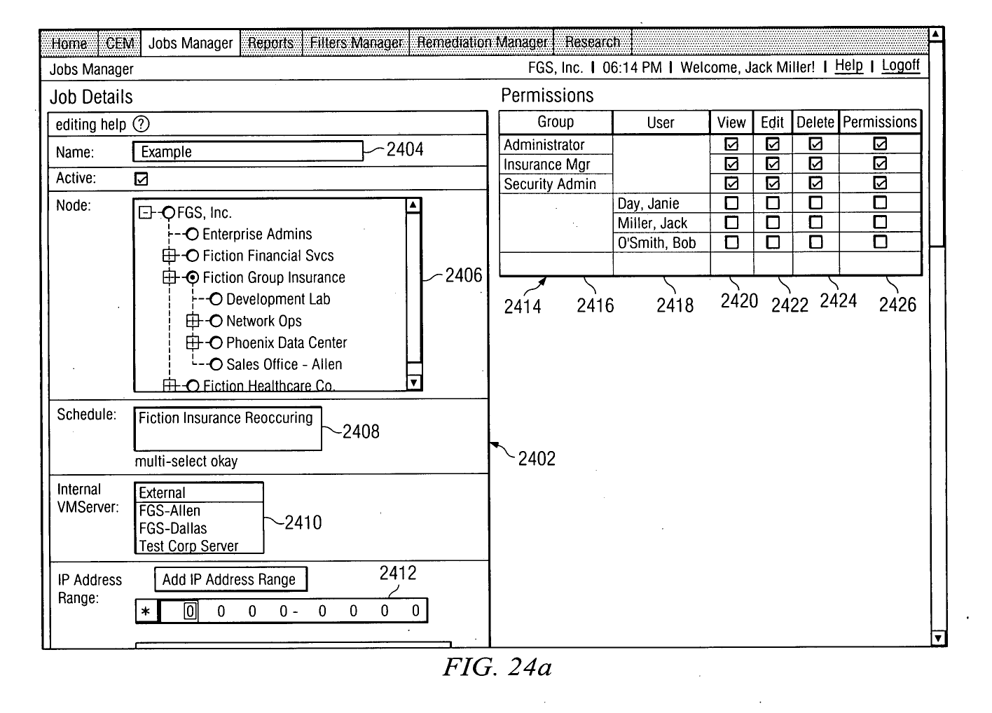

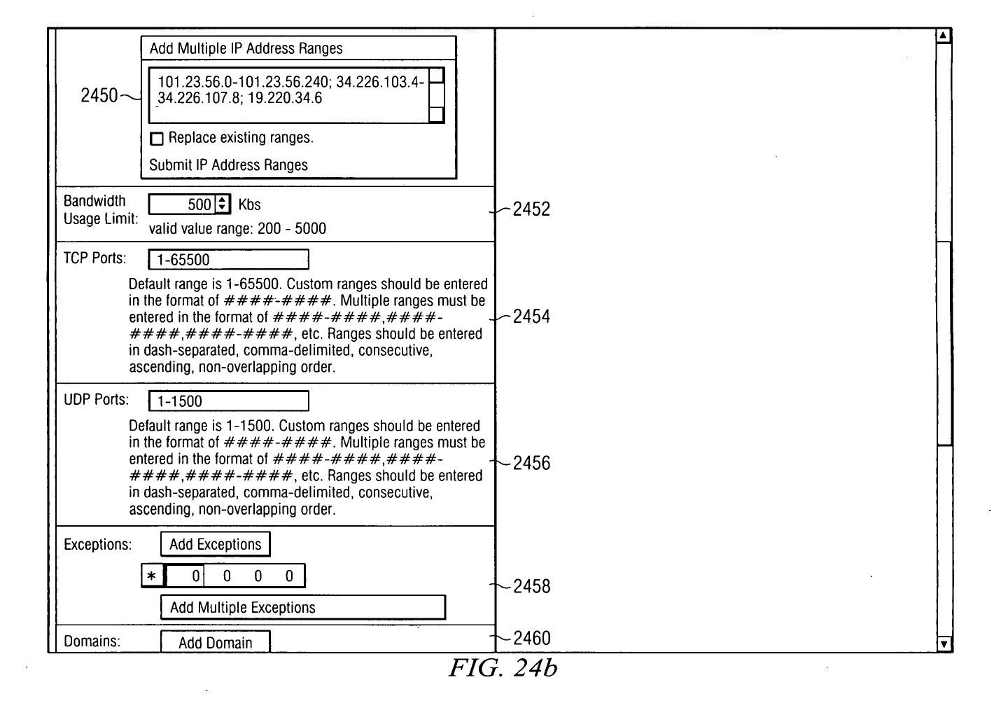

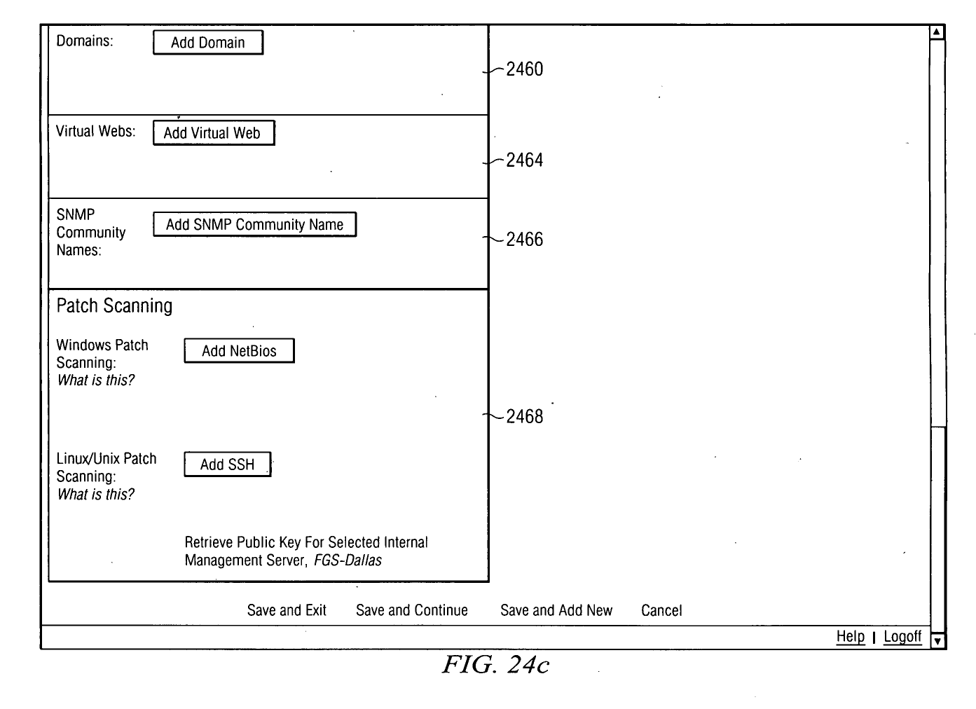

Referring now to FIGS. 24a-c, there is illustrated the jobs details and permissions page. This page would be displayed when adding or modifying a job. The jobs details portion 2402 includes a name field 2404 for entering the name of a job. A node field 2406 includes a listing of the nodes with which the job may be associated. A schedule field 2408 provides the ability to establish the schedule on which the job will be run on the particular nodes established in the node field 2406. The internal management server (VM Server appliance 508 and 514) field 2410 allows selection of the management server the job will be running from for controlling the scheduled job process. Finally, the IP address range field 2412 provides for a listing of IP addresses that may be selected for the created job. The IP address ranges may be added, edited or deleted using associated buttons with the IP address range field 2412. Additional selection or exceptions to the IP addresses, ports to test or skip, domain names and the ability to test for patch level compliance is also provided.

The Add Multiple IP Address Ranges field 2450 (FIG. 24b) enables the listing of various for a job. Field 2452 enables the limiting of bandwidth usage. TCP Ports may be listed in field 2454, and UDP Ports are listed in field 2456. Exceptions are established in field 2458. The add domain button 2460 enables the adding of domains. Virtual webs are added using the Add Virtual Web button 2464 (FIG. 24c). An SNMP Community Name is added with button 2466. The patch scanning section 2468 enables scanning for available patches.

The permissions table 2414 (FIG. 24a) includes a listing of permissions for particular groups 2416 and users 2418. As described herein above, the user may be granted permissions of the view type 2420, the edit type 2422, the delete type 2424 and the permissions type 2426.

Referring now to FIG. 25, there is illustrated the process for adding a job within the jobs manager module 716. The jobs manager module 716 is accessed by clicking a jobs manager tab at step 2502 from the main portal page. By clicking the add job button at step 2504, the jobs details and permissions page (FIG. 24) appears. The user enters the desired job details and permissions at step 2506. This information is saved at step 2508.

Referring now to FIG. 26, there is illustrated the process by which an existing job may be modified. The jobs manager module 716 is accessed by clicking on the jobs manager tab at step 2602 and on the edit tab 2604 associated with the particular job that is to be edited. The job info is modified at step 2606 within the job details and permission page (FIG. 24) and the user saves the information at step 2608.

Referring now to FIG. 27, there is illustrated the process for deleting a job from the jobs manager module 716 by initially clicking on the jobs manager tab at step 2702 from the main portal page. The job to be deleted is located by first locating the appropriate company node at step 2704 and then locating the particular job at step 2706 attached to the node. The job is deleted by clicking on the delete job button 2324 at step 2708. Responsive to clicking of the delete job button 2324 a delete confirmation is provided at step 2710 which the user can confirm at step 2712 to complete the job deletion process.

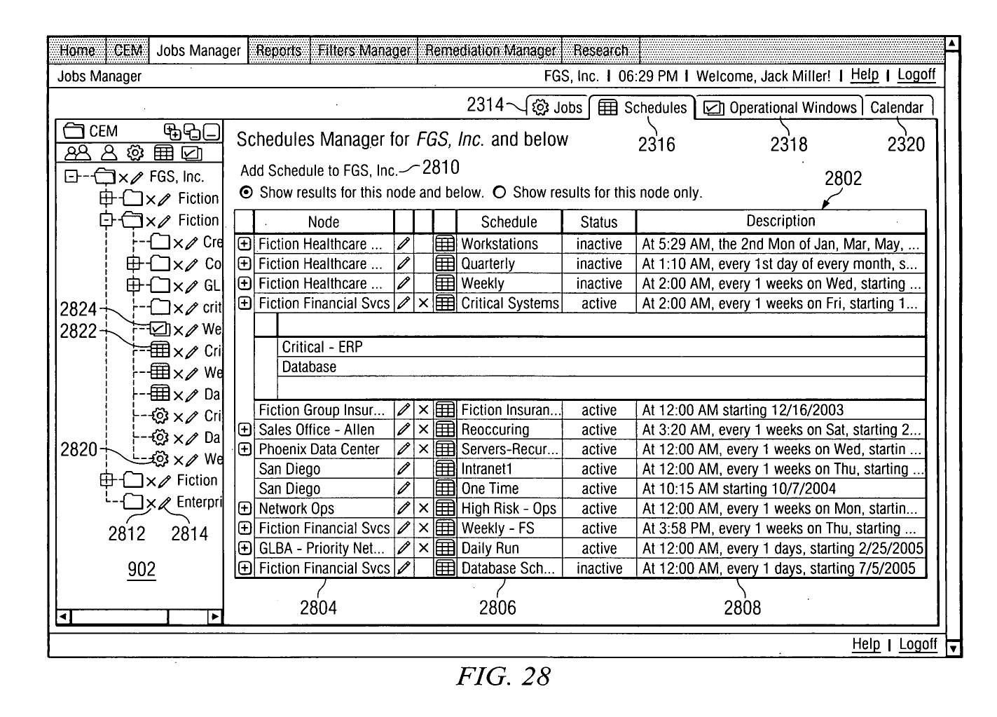

Referring now to FIG. 28, there is illustrated the schedule page that appears responsive to clicking on the schedule tab 2316 of the jobs manager module 716. A schedule listing 2802 includes a node column 2804 indicating the node associated with a particular schedule, a schedule column 2806 indicating the schedule for the job and a description column 2808 providing a brief description of the schedule. An add button 2810 enables the addition of schedules. A delete button 2812 enables the deletion of schedules, and an edit button 2814 enables the editing of schedules. The tree structure 902 also includes job icons 2820 and schedule icons 2822 and operational window icon 2824. The job icons 2820 indicate the association of a job with a particular node. The schedule and operational window icons 2822 and 2824 indicate the association of a schedule or operational window with a particular job under a node.

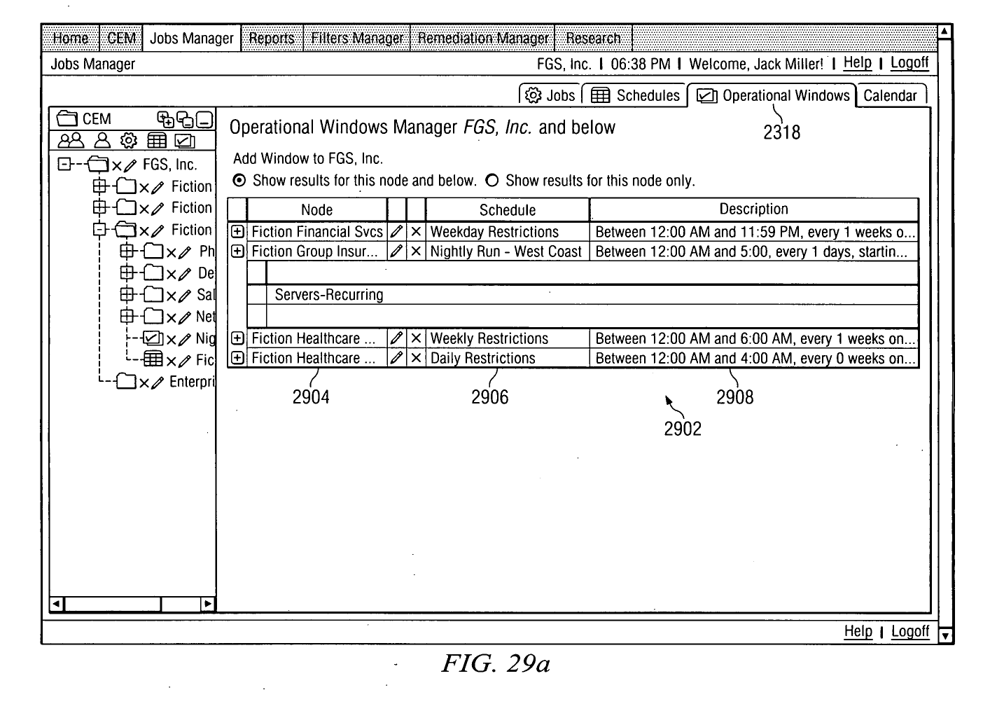

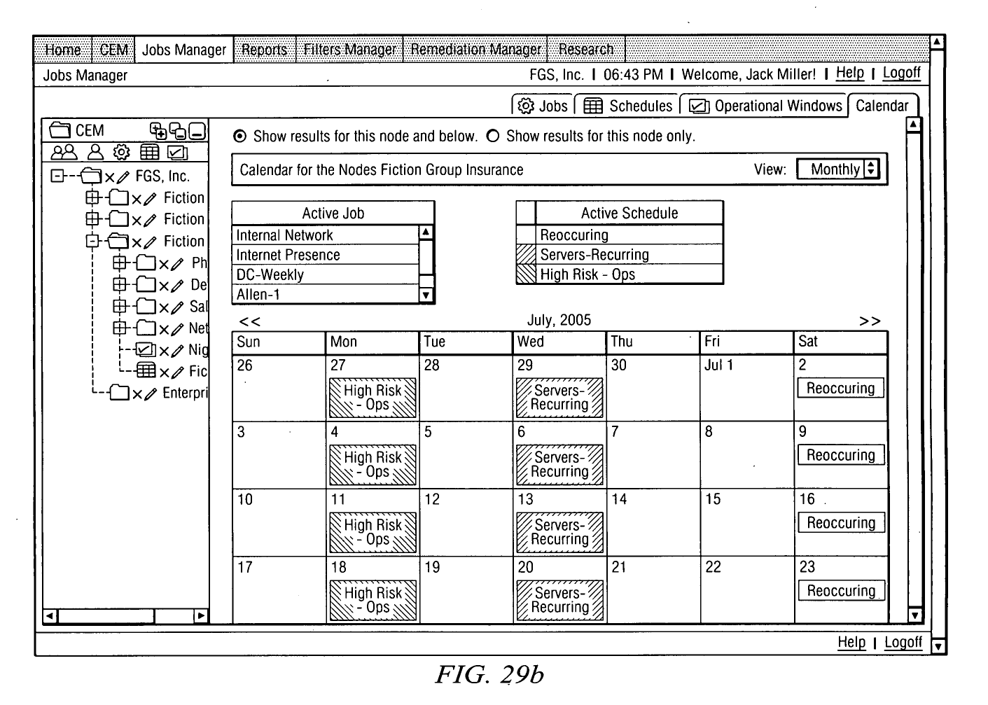

Referring now to FIG. 29a, there is provided an illustration of the operational windows listing 2902 accessed by clicking on the operational windows tab 2318. A node column 2904 includes the node associated with an operational window. The operational window column 2906 has a brief name for the operational window and a description column 2908 includes a brief description of the operational window for a node. Operational windows specify specific time periods of dates available to run jobs. A job may run on consecutive periods as required to complete a process. The windows listing also includes buttons for adding, modifying and deleting an operational window.

FIG. 29b illustrates the calendar screen accessed through the calendar tab 2320. The calendar screen enables a user to see where jobs have been created. The calendar screen also fails to display a job if the job has been improperly created.

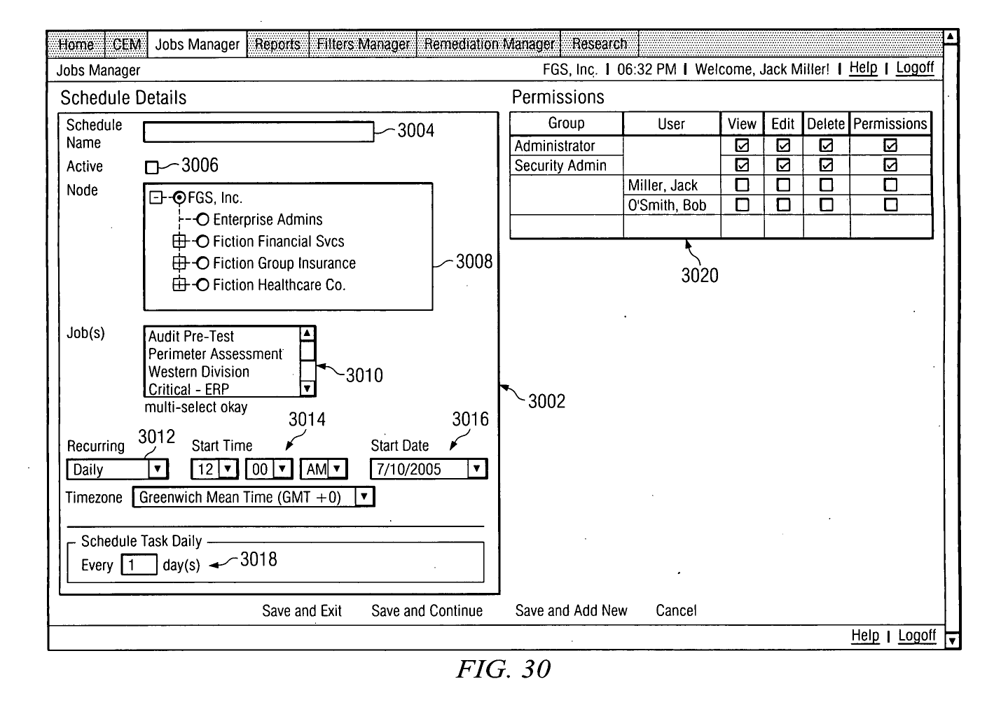

Referring now to FIG. 30, there is illustrated the schedule details and permission page which is accessed responsive to the addition of a schedule or modification of a schedule. The schedule details and permissions page includes a schedule details portion 3002 for describing a particular schedule. A schedule name field 3004 enables entry of a name to be associated with a schedule. An active field 3006 provides an indication of whether a schedule is active or inactive. A schedule and a job have to be both active for a job to run. A node field 3008 provides an indication of the nodes associated with a particular schedule, and the jobs field 3010 provides an indication of the jobs associated with the schedule. The schedule job field 3012 enables an indication of the frequency of a particular schedule to be run such as daily, weekly, monthly, etc. The start time field 3014 enables entry of a particular start time for the schedule and the start date field 3016 provides a calendar date a job schedule is to begin. The schedule task daily field 3018 enables an indication of the number of days between runnings of a particular schedule. The permissions listing 3020 provides an indication of the security permissions associated with particular groups and users as described previously herein.

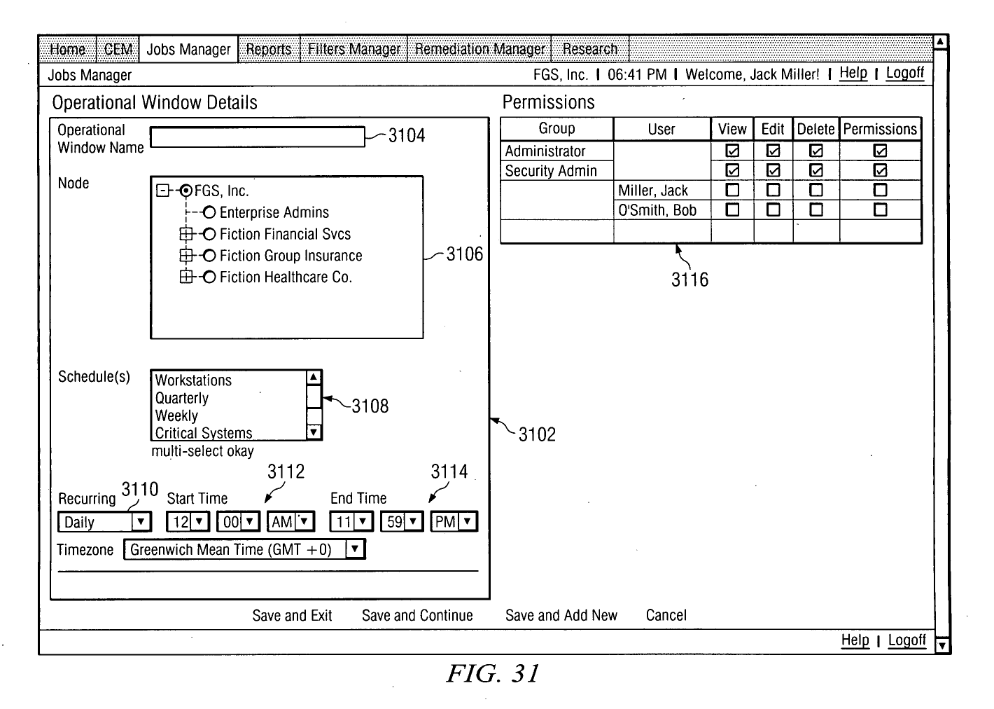

Referring now to FIG. 31, there is provided the operational window details and permissions page. The operational window details portion 3102 includes an operational windows name field 3104 for providing a name for the operational window. A node field 3106 provides for an indication of the node associated with the operational window, and the schedules field 3108 provides an indication of the schedule or schedules associated with the operational window. A schedule job field 3110 provides for an indication of the frequency of the operational window either daily, weekly, monthly, etc. A start time field 3112 and an end time field 3114 provide an indication of the beginning and ending times of a particular operational window. The permissions portion 3116 provides for an indication of group and user permissions as described previously herein above.

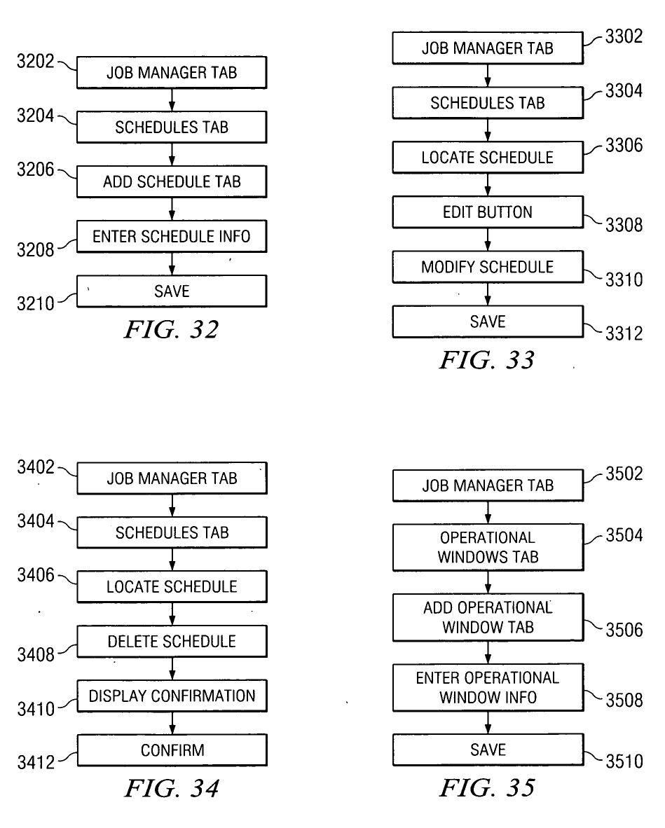

Referring now to FIG. 32, there is illustrated a flow diagram describing the process for creating a schedule within the jobs manager module 716. The process is initiated by clicking on the jobs manager tab at step 3202 in the main portal page. The schedules tab 2316 is clicked to access the schedules page (FIG. 28) and the add schedule button is clicked at step 3206 to open the schedules detail and permissions page (FIG. 30). The schedule details and permissions may then be filled out at step 3208 and saved at step 3210.

Referring now to FIG. 33, there is illustrated the process by which a schedule may be modified. The jobs manager tab is clicked on the main portal page at step 3302. The schedules tab is actuated at step 3304 to access the schedules page (FIG. 28), and the desired schedule is located by clicking on the appropriate companies or locations in the tree structure 902 until the desired schedule is shown. By clicking on the edit button 2814 next to the schedule in the tree structure 902 the schedules and permission page (FIG. 28) will be opened. The schedule is modified at step 3310 as desired. The modified information is saved at step 3312.

Referring now to FIG. 34, there is illustrated the process for deleting a schedule. The jobs manager tab is actuated at step 3402, and the schedules tab is actuated at step 3404. The appropriate schedule is located in the tree structure 902 at step 3406, and the delete button 2812 associated with the schedule is clicked at step 3408 to delete the selected schedule. Responsive to the actuation of the delete button, a display confirmation is displayed at step 3410, and the user must confirm the deletion at step 3412.

Referring now to FIG. 35, there is illustrated the process for creating an operational window within the jobs manager module 716. The jobs manager tab is actuated at step 3502 within the main portal, and the operational windows tab 2318 is actuated to display the operational windows screen (FIG. 29). The add operational window tab is actuated at step 3506 to open the operational window details and permissions page (FIG. 29). The appropriate information is entered into the details portion and the permissions portion of the operational window at step 3508 and this information is saved at step 3510.

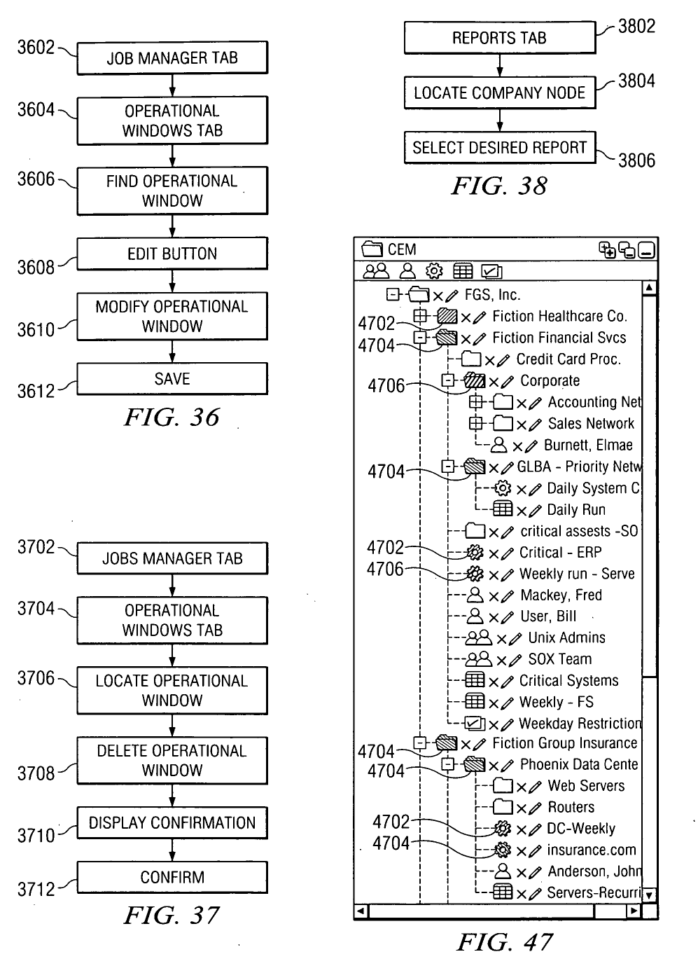

Referring now to FIG. 36, there is illustrated the process for modifying an operational window wherein the process is initiated by actuating the jobs manager tab at step 3602. The operational window tab is actuated at step 3604 to enable the appropriate operational window to be found within the tree structure 902 at step 3606. The edit button next to the located operational window is actuated at step 3608 causing the details and permission window to be opened (FIG. 29). The desired information is modified within the operational window at step 3610 and saved at step 3612.

Referring now to FIG. 37, there is illustrated the process for deleting an operational window. The jobs manager tab within the main portal is actuated at step 3702, and the operational windows tab 2318 is actuated to open the operational window screen (FIG. 29). The operational window to be deleted is located within the tree structure 902 at step 3706, and the delete button next to the operational window is actuated at step 3708. Responsive to the delete button for the operational window, a display confirmation is provided to the user at step 3710. The user may complete the deletion of the operational window by confirming the deletion at step 3712.

Referring now to FIG. 38, there is illustrated the process by which a user may access the reports module 726 to provide a number of reports for various individuals using the vulnerability management system 702. The reports module 726 is accessed via the main portal of the vulnerability management system 702 by clicking on the reports tab at step 3802. A desired node within the tree structure 902 is located at step 3804 for which a report is desired to be generated. The particular type of report is selected at step 3806 for generation with respect to the company node that has been located at step 3804.

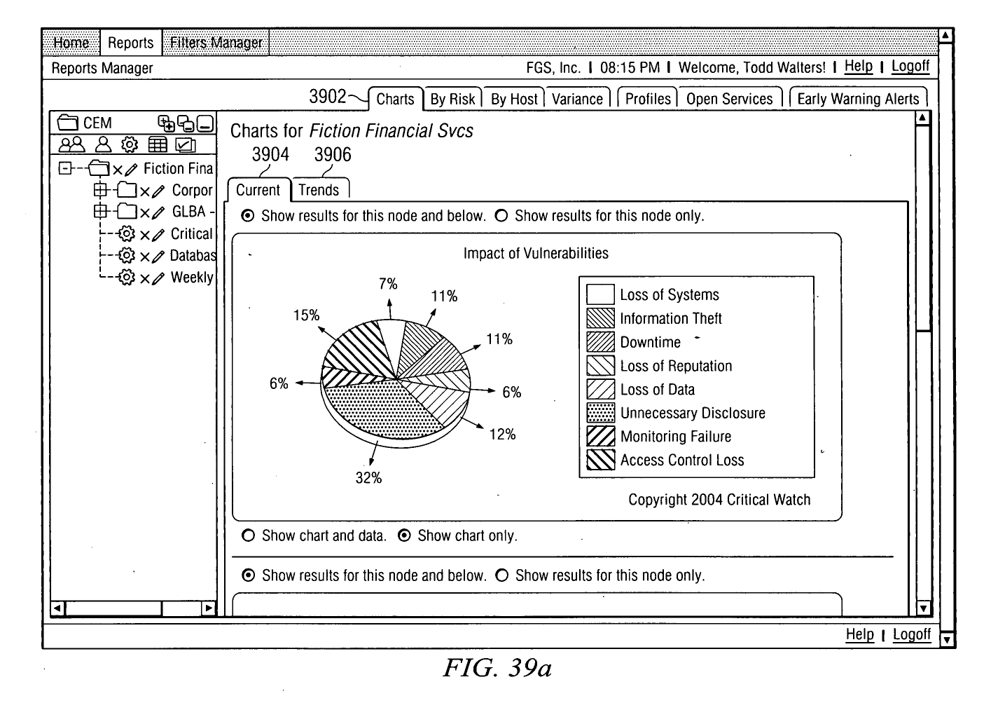

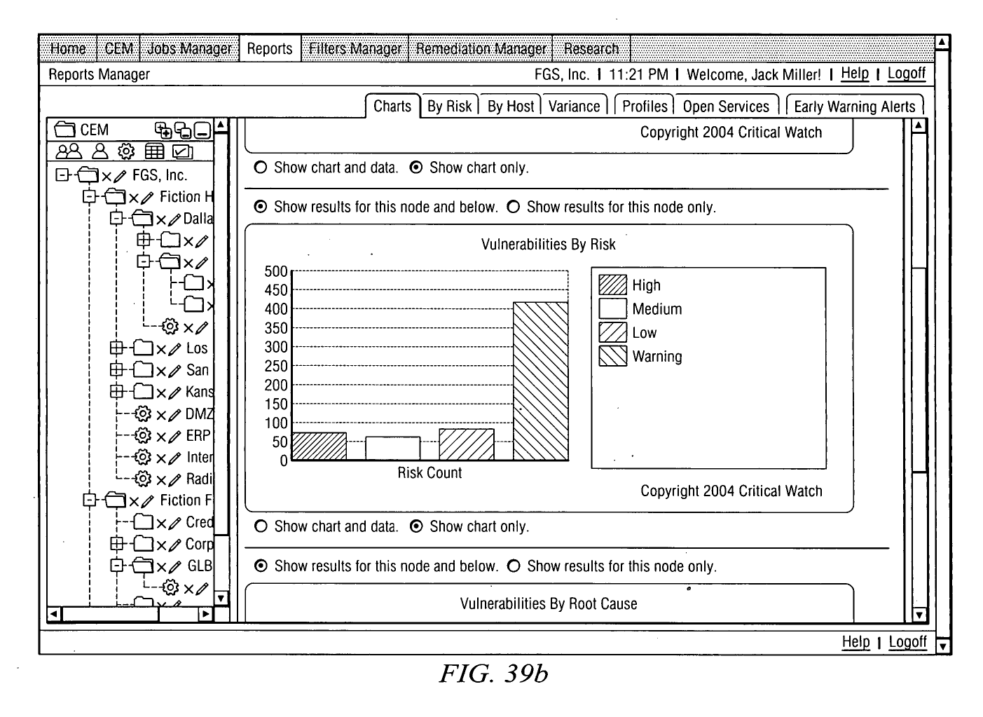

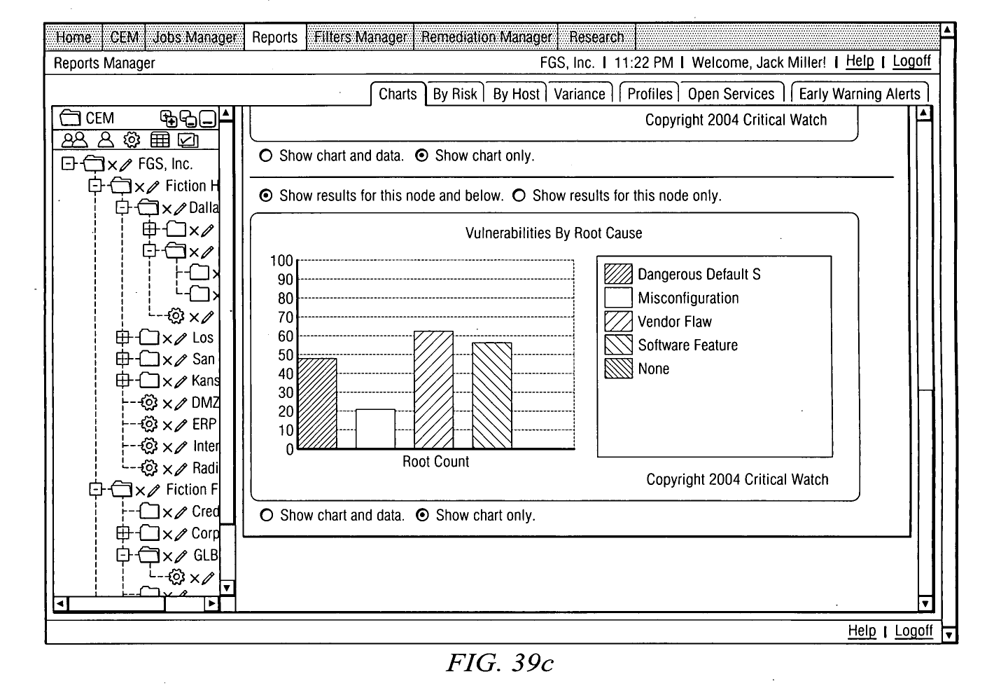

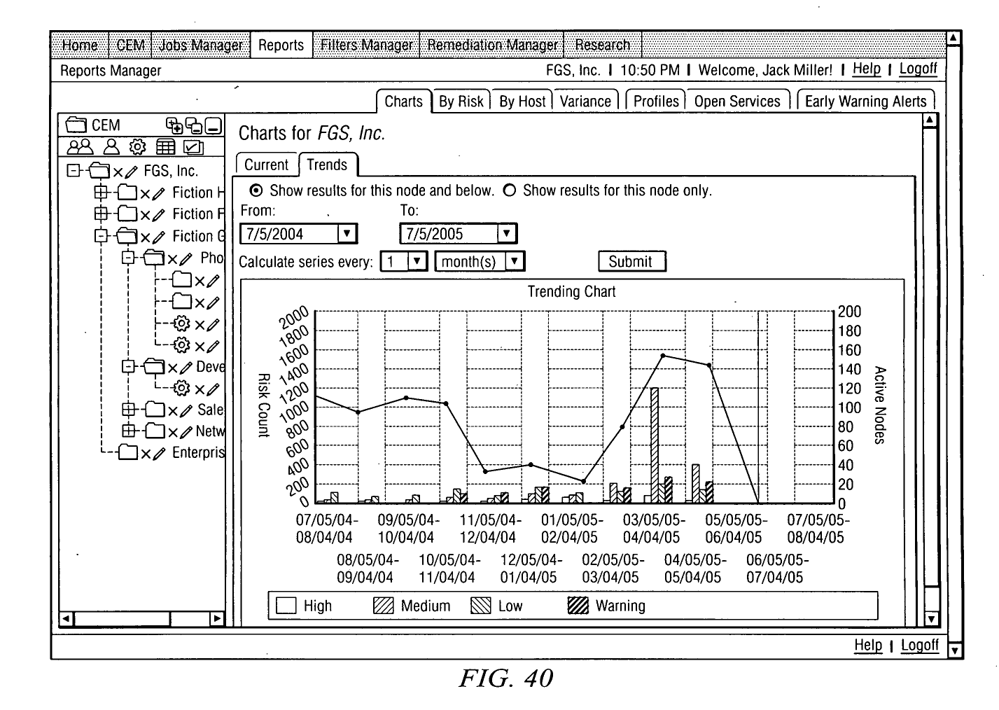

Referring now to FIGS. 39a-c, there is illustrated the report displayed responsive to selection of the charts tab 3902. Under the current tab 3904 of the charts tab 3902 selection, a display of a pie chart with the impact of vulnerabilities is provided. As can be seen, there may be a selection to provide the results for the selected node and all sub-nodes of this node or only for the node selected and by scrolling down more chart and bar graphs are available vulnerability by risk and vulnerability by root cause. Referring now to FIG. 40, there is illustrated the screen display responsive to selection of the charts tab 3902 and the trend tab 3906. These selections provide a trend showing how many network devices were scanned over different period of time selected (weekly, monthly, yearly) and the bar graphs represent the number of vulnerabilities found with risk designation of high, medium, low and warning. By clicking on different folders on the CEM and requesting different trends runs the system will recalculate the trend graph for the folder requested and all the folders below.

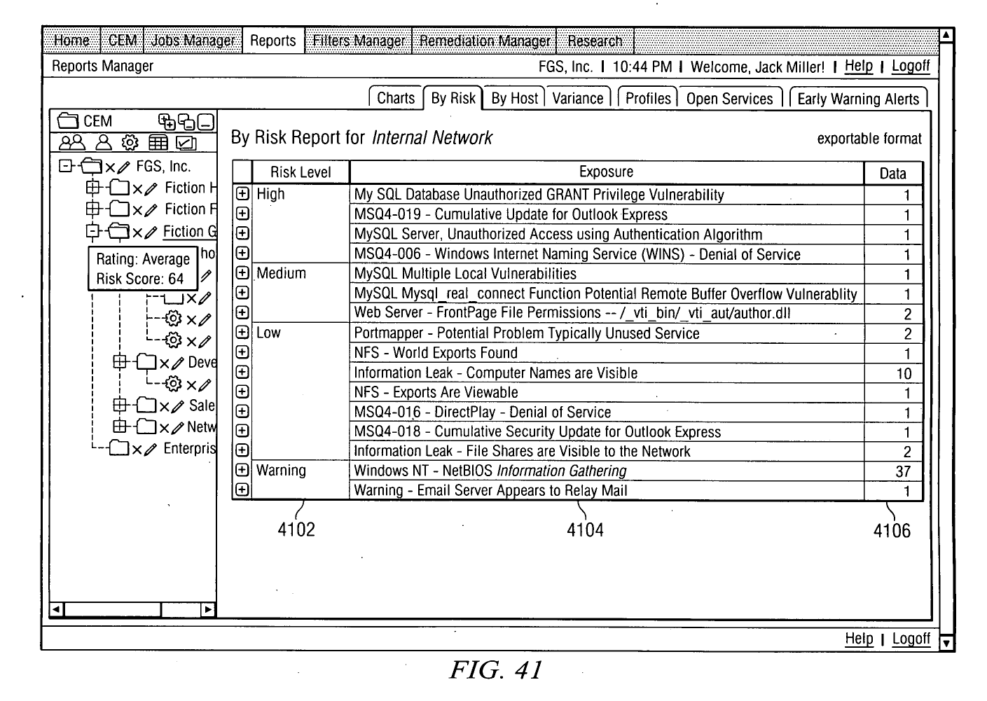

Referring now to FIG. 41, there is illustrated the report display provided responsive to selection of a report by risk. The risk levels are broken down into high, medium, low and warning conditions in column 4102, and the particular exposure related to the risk level is described in column 4104. The total number of occurrences of the exposure are illustrated in column 4106. The by risk selection displays vulnerability information in cascading format order between high, medium, low and warning risk levels. Vulnerability titles for each risk level are included along with the number of incidents occurring for each level. By expanding each vulnerability using the (+) sign a detail sections will provide in-depth descriptions of each vulnerability title including impact, description, concern, solution and references. The computers affected by the risk expands as required to localize the risk to a specific Internet protocol and port.

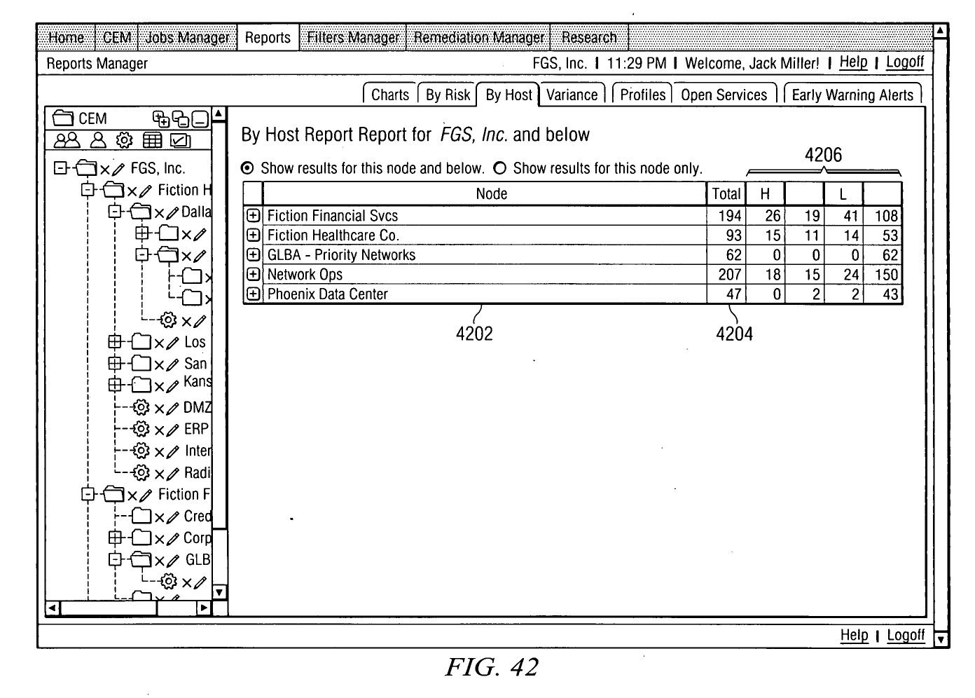

Referring now to FIG. 42, there is illustrated the report provided by the vulnerability management system 702 responsive to the selection of the report by host. The by host configuration illustrates the nodes for which particular problems may arise in column 4202 and illustrates the total number of problems in columns 4204. The high, medium, low and warning columns 4206 illustrate the particular problems occurring by host. The by host selection displays vulnerabilities for specific nodes and groups. This allows a view of all of the vulnerabilities for an identified location. Vulnerability titles are listed in high, medium, low and warning risk level order. Vulnerability details are displayed by clicking on an associated title. By expanding on any node (+) a list of all the IP addresses will be displayed to show individual host and their specific vulnerabilities.

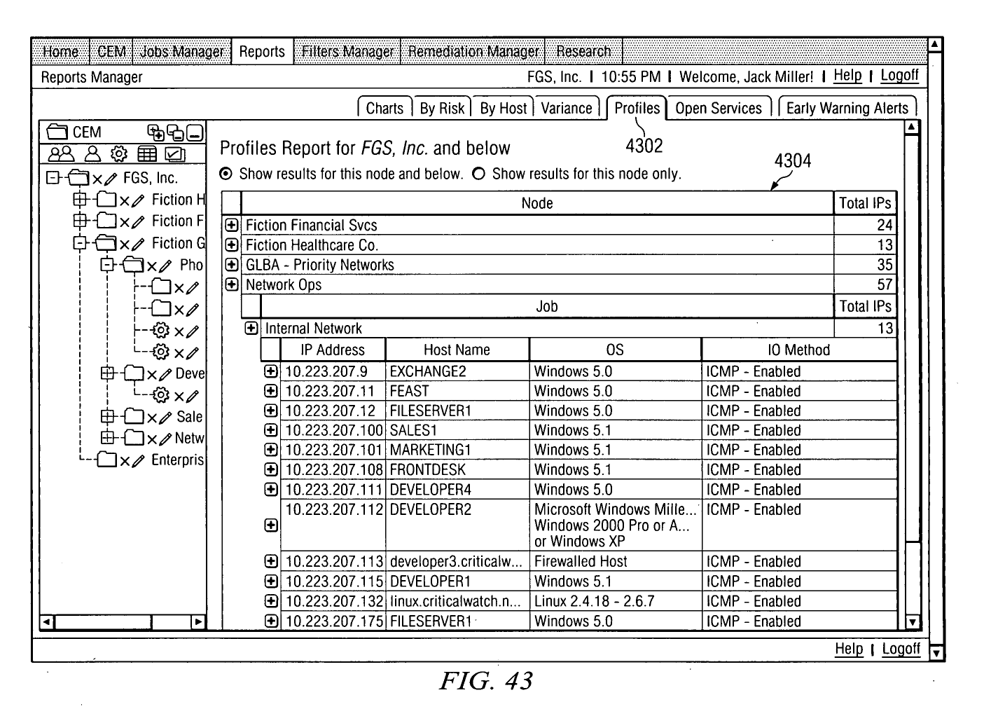

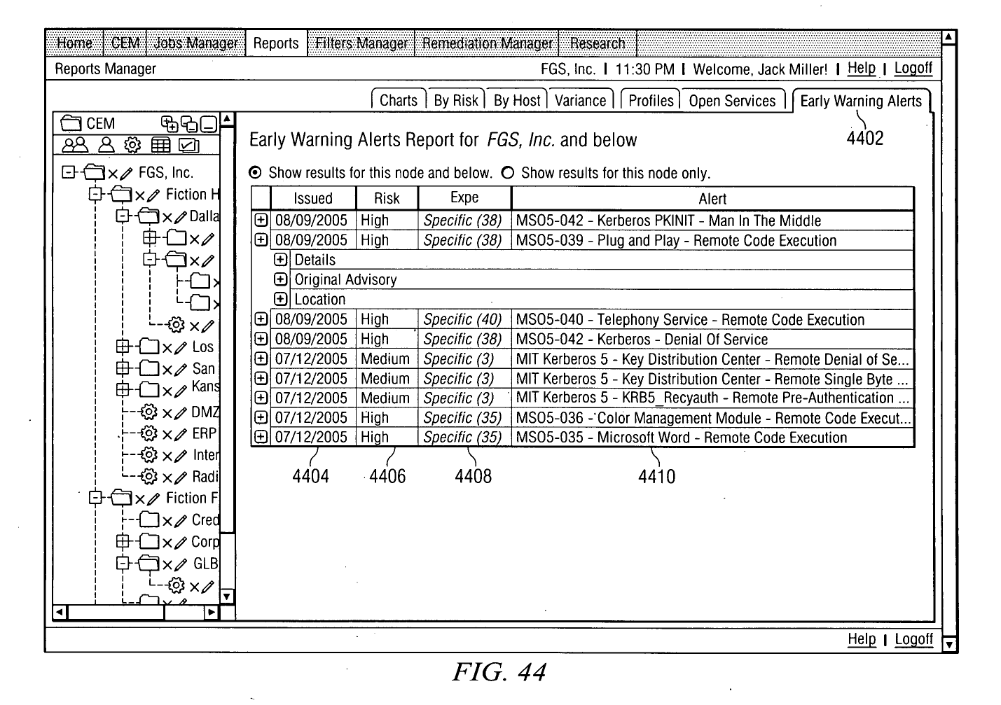

Referring now to FIG. 43, there is illustrated the reports displayed by the profiles tab 4302. The profile selection allows the viewing of nodes and enables drill down by IP address, device name operating system ports etc. Particular nodes may be accessed by clicking on the node 4304 to provide devices details. FIG. 44 illustrates the reports displayed by the early warning alerts tab 4402. The early warning alerts tab 4402 shows alerts issued with date issued, risk level, type and a description of the alert. The alert issue date is provided in column 4404. The risk level associated with the alert is shown in column 4406. The type of alert is illustrated in column 4408 and the specific description of the alert is provided in column 4410. By expanding each alert (+) more details are provided to show how to fix the problem or have a work around.

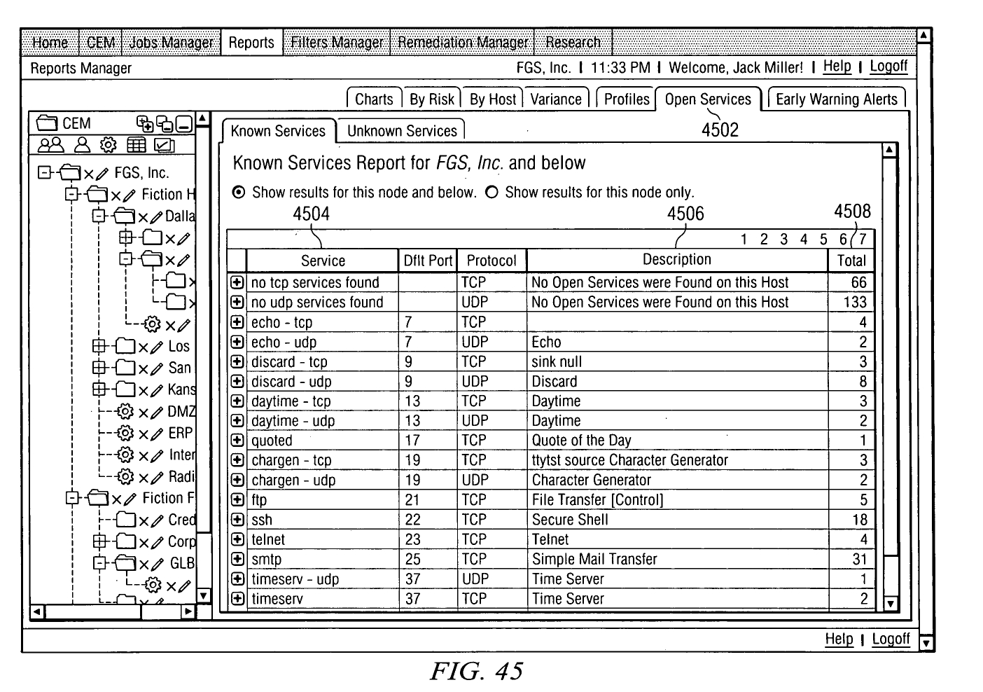

FIG. 45 illustrates the report displayed by open services tab 4502. The open services tab 4502 displays vulnerabilities for known and unknown service types. Known services are defined as specific components that have been tested. Unknown services are open ports, where the vulnerability testing system is uncertain of the component detected like Trojan horses or pear to pear connection. The services column 4504 describes the service name and the description column 4506 provides a description of the service. Column 4508 provides total number occurrences of the service. The vulnerability management system enables the customization of services for any particular organizational entity and may be uniquely configured according to their security needs.

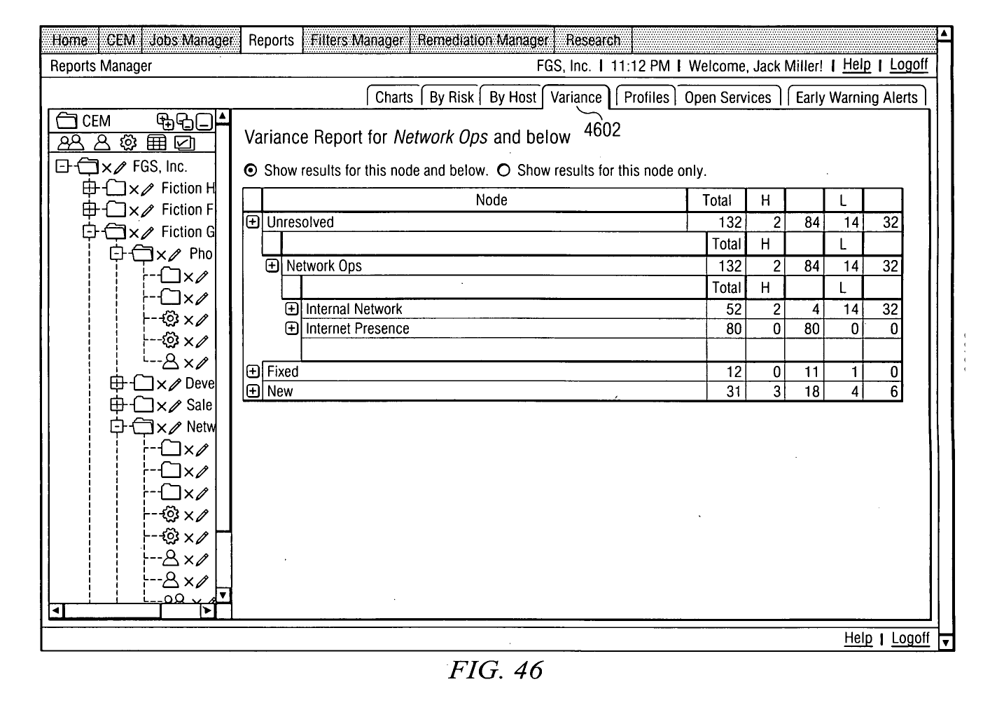

FIG. 46 provides a variance report at different level of the CEM 902. Variance report shows the changes to the number of vulnerabilities from a previous scan to a new scan showing what vulnerabilities were fixed, what was not fixed and what new vulnerabilities were found in the last scan.

FIG. 47 show folders and jobs in the CEM. Both folders and individual job icons on the CEM are color-coded based on test results of vulnerabilities found. The color-coded scoring system is based on risk factors, likelihood, potential business impact and number of instances. A job with red score will influence the scoring more if it has more IP addresses in the test results. Scoring is reflective of the hierarchy and reflects a weighted average based on number of assets in conjunction with the vulnerability weight. A folder is colored based on the average collective scores of all the jobs, weighted by percentage of active, scored IP addresses, under that folder and all the sub folders under the folder. Folders scores are averaged, weighted by percentage of active, scored IP addresses contained within, to provide the scores to folders above them all the way to the top of the CEM structure where the score is for the entire enterprise. Folder and job scores colors are red 4702, green 4704 and yellow 4706. These colors enable users and groups to quickly hone in on problem areas from the top of the enterprise all the way to a specific problem area in a department level set of IP addresses where the problem reside, as well as to see who are the stakeholders responsible for the assets that is bringing down the score of the entire enterprise.

The vulnerability management system enables the organizational entity to define their CEM structure in sufficient resolution to give management, IT, or audit entities the visibility, manageability and control that is necessary for them to perform their particular jobs. The organizational entity has the ability to define users and the particular privileges associated with these users according to their own unique taxonomy. The defining and scheduling of security assessments may then be created using this design taxonomy structure. The results of the security assessments may then be provided to various entities in a format most appropriate to their job responsibilities. This structure enables the organizational entity to manage according to their particular business structure, team accountability structure, asset type, technology platform or any other desired logical grouping. The described vulnerability management system is an enterprise wide system that allows users to fit security into their organization's business functions and network rather than fitting the organization into an arbitrary security environment or tool set. The technology allows distributing the functionality of security vulnerability management through out the enterprise, pushing down the security function from top down while distributing the work load to asset owners.

It will be appreciated by those skilled in the art having the benefit of this disclosure that this invention provides a system and method for management of the entire life cycle of vulnerability management and provide visibility measurability and control through out the enterprise. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A graphical user interface for managing vulnerability life cycle of a computer network of an organizational entity, comprising:
a multilevel tree structure including a plurality of nodes, wherein each node of the plurality of nodes is uniquely associated with a designated unit within the organizational entity;
at least one user icon connected to at least one of the nodes, the at least one user icon associated with a particular individual;
at least one group icon connected to at least one of the nodes, the at least one group icon associated with a plurality of individuals;
wherein each of the plurality of nodes, at least one user icon and at least one group icon are dynamically modifiable according to a structure of the organizational entity.

2. The graphical user interface of claim 1, further including a first icon associated with each of the plurality of nodes, at least one user icon and at least one group icon, the first icon enabling deletion of the node, the user icon or the group icon associated with the first icon.

3. The graphical user interface of claim 2, further including a second icon associated with each of the plurality of nodes, at least one user icon and at least one group icon, the second icon enabling editing of data associated with the node, the user icon or the group icon associated with the second icon.

4. The graphical user interface of claim 1, further including:
a first icon for adding a new node to the multilevel tree structure;
a second icon for adding a new user icon to a node of the multilevel tree structure; and
a third icon for adding a new group icon to the node of the multilevel tree structure.

5. The graphical user interface of claim 1, wherein the designated unit comprises at least one of locations, departments, divisions, servers, computers, IP addresses, auditor's functions, regulatory compliance, mission critical devices, and other designations.

6. The graphical user interface of claim 1, further including a permissions page for designating permissions that are granted to a user and a group in a particular node for a particular functional object, wherein the permissions are also granted to any node below the particular node in the multilevel tree structure.

7. The graphical user interface of claim 6, wherein the multilevel tree structure comprises a subset of the plurality of nodes of the multilevel tree structure based on the permissions granted in the permissions page.

8. The graphical user interface of claim 6, wherein the permissions granted comprise functional objects including tabs, nodes, schedules, jobs, operational windows, permissions, reports, filters and other functions.

9. The graphical user interface of claim 1, further including a page for selecting at least one node of the plurality nodes in the multilevel tree structure and for generating vulnerability assessment jobs for testing a vulnerability of IP addresses associated with the selected at least one node.

10. The graphical user interface of claim 1, further including a page for selecting at least one node of the plurality nodes in the multilevel tree structure and for selecting a type of vulnerability assessment report to be generated for IP addresses associated with at least one of the selected at least one node or at least one job within at least one node.

11. The graphical user interface of claim 1, further including a page for selecting at least one node of the plurality nodes in the multilevel tree structure and for selecting a remediation work flow of at least one vulnerability to be generated for IP addresses associated with the selected at least one node.

12. The graphical user interface of claim 1, further including a page for selecting at least one node of the plurality nodes in the multilevel tree structure and for selecting filtering of at least one vulnerability to be generated for IP addresses associated with the selected at least one node.

13. The graphical user interface of claim 1, further including a page for selecting at least one node of the plurality nodes in the multilevel tree structure, and for selecting a risk score of the node in comparison to other nodes and for selecting the job icon under the node to see a reason attributing to the risk score.

14. The graphical user interface of claim 1, wherein at least one job icon is connected to at least one of the nodes, the at least one job icon is associated with a particular job that has been established for the at least one of the nodes.

15. The graphical user interface of claim 1, wherein at least one schedule icon is connected to at least one of the nodes, the at least one schedule icon is associated with a particular job that has been established for the at least one of the nodes.

16. The graphical user interface of claim 1, wherein at least one operational window icon is connected to at least one of the nodes, the at least one operational window icon is associated with a particular schedule of a particular job that has been established for the at least one of the nodes.

17. A graphical user interface for managing vulnerability life cycle of a computer network of an organizational entity, comprising:
a multilevel tree structure including a plurality of nodes, wherein each node of the plurality of nodes is uniquely associated with a designated unit within the organizational entity;
at least one user icon connected to at least one of the nodes, the at least one user icon associated with a particular individual;
at least one group icon connected to at least one of the nodes, the at least one group icon associated with a plurality of individuals;
wherein each of the plurality of nodes, the at least one user icon and the at least one group icon are dynamically modifiable according to a structure of the organizational entity;
a first icon associated with each of the plurality of nodes, the at least one user icon and the at least one group icon, the first icon enabling deletion of the node, the user icon or the group icon associated with the first icon;
a second icon associated with each of the plurality of nodes, and the at least one user icon and at least one group icon, the second icon enabling editing of data associated with the node, the user icon or the group icon associated with the second icon; and
a permissions page for designating permissions that are granted to a user and a group within a particular node for functional objects, wherein the permissions are also granted to any node below the particular node in the multilevel tree structure.

18. The graphical user interface of claim 17, further including:
a first icon for adding a new node to the multilevel tree structure;
a second icon for adding a new user icon to a node of the multilevel tree structure; and
a third icon for adding a new group icon to the node of the multilevel tree structure.

19. The graphical user interface of claim 17, wherein the designated unit comprises at least one of departments, divisions, servers, computers, IP addresses, auditor's functions, regulatory compliance, mission critical devices, and other designations.

20. The graphical user interface of claim 17, further including a page for selecting at least one node of the plurality nodes in the multilevel tree structure and for generating vulnerability assessment jobs for testing a vulnerability of IP addresses associated with at least one of the selected at least one node or at least one job contained by the at least one node.

21. The graphical user interface of claim 17, further including a page for selecting at least one node of the plurality nodes in the multilevel tree structure and for selecting a type of vulnerability assessment report to be generated for IP addresses associated with the selected at least one node.

22. The graphical user interface of claim 17, further including a page for selecting at least one node of the plurality nodes in the multilevel tree structure and for selecting a remediation work flow of at least one vulnerability to be generated for IP addresses associated with the selected at least one node.

23. The graphical user interface of claim 17, further including a page for selecting at least one node of the plurality nodes in the multilevel tree structure and for selecting filtering of at least one vulnerability to be generated for IP addresses associated with the selected at least one node.

24. The graphical user interface of claim 17, further including a page for selecting at least one node of the plurality nodes in the multilevel tree structure, and for selecting a risk score of the node in comparison to other nodes and for selecting the job icon under the node to see a reason attributing to the risk score.

25. The graphical user interface of claim 17, wherein at least one job icon is connected to at least one of the nodes, the at least one job icon is associated with a particular job that has been established for the at least one of the nodes.

26. The graphical user interface of claim 17, wherein at least one schedule icon is connected to at least one of the nodes, the at least one schedule icon is associated with a particular job that has been established for the at least one of the nodes.

27. The graphical user interface of claim 17, wherein at least one operational window icon is connected to at least one of the nodes, the at least one operational window icon is associated with a particular schedule of a particular job that has been established for the at least one of the nodes.

28. An apparatus, comprising:
a computer-readable storage medium containing a set of instructions for a general purpose computer;
wherein execution of the set of instructions by the general purpose computer configures the general purpose computer to:
generate a graphical user interface for managing vulnerability life cycle of a computer network of a computer network of an organizational entity, the graphical user interface including:
a multilevel tree structure including a plurality of nodes, wherein each node of the plurality of nodes is uniquely associated with a designated unit within the organizational entity;
at least one user icon connected to at least one of the nodes, the at least one user icon associated with a particular individual;
at least one group icon connected to at least one of the nodes, the at least one group icon associated with a plurality of individuals;
wherein each of the plurality of nodes, the at least one user icon and at least one group icon are dynamically modifiable according to a structure of the organizational entity.

29. The apparatus of claim 28, further including a first icon associated with each of the plurality of nodes, the at least one user icon and the at least one group icon, the first icon enabling deletion of the node, the user icon or the group icon associated with the first icon.

30. The apparatus of claim 29, further including a second icon associated with each of the plurality of nodes, the at least one user icon and the at least one group icon, the second icon enabling editing of data associated with the node, the user icon or the group icon associated with the second icon.

31. The apparatus of claim 28, further including:
a first icon for adding a new node to the multilevel tree structure;
a second icon for adding a new user icon to a node of the multilevel tree structure; and
a third icon for adding a new group icon to the node of the multilevel tree structure.

32. The apparatus of claim 28, further including a permissions page for designating permissions that are granted to a particular node and for designating permissions for objects, wherein the permissions are also granted to any node and its contained objects below the particular node in the multilevel tree structure.

33. The graphical user interface of claim 28, further including a page for selecting at least one node of the plurality nodes in the multilevel tree structure and for generating vulnerability assessment jobs for testing a vulnerability of IP addresses associated with the selected at least one node.

34. The graphical user interface of claim 28, further including a page for selecting at least one node of the plurality nodes in the multilevel tree structure and for selecting a type of vulnerability assessment report to be generated for IP addresses associated with at least one of the selected at least one node or at least one job contained by the at least one node.

35. The graphical user interface of claim 28, further including a page for selecting at least one node of the plurality nodes in the multilevel tree structure and for selecting a remediation work flow of at least one vulnerability to be generated for IP addresses associated with the selected at least one node.

36. The graphical user interface of claim 28, further including a page for selecting at least one node of the plurality nodes in the multilevel tree structure and for selecting filtering of at least one vulnerability to be generated for IP addresses associated with the selected at least one node.

37. The graphical user interface of claim 28, further including a page for selecting at least one node of the plurality nodes in the multilevel tree structure, and for selecting a risk score of the node in comparison to other nodes and for selecting the job icon under the node to see a reason attributing to the risk score.

38. The graphical user interface of claim 28, wherein at least one job icon is connected to at least one of the nodes, the at least one job icon is associated with a particular job that has been established for the at least one of the nodes.

39. The graphical user interface of claim 28, wherein at least one schedule icon is connected to at least one of the nodes, the at least one schedule icon is associated with a particular job that has been established for the at least one of the nodes.

40. The graphical user interface of claim 28, wherein at least one operational window icon is connected to at least one of the nodes, the at least one operational window icon is associated with a particular schedule of a particular job that has been established for the at least one of the nodes.
